(19) United States
(12) Patent Application Publication
(10) Pub. No.: US 2024/0410780 A1
(43) Pub. Date: Dec. 12, 2024

(54) THREE-DIMENSIONAL (3D) CONTINUOUSLY SCANNING LASER VIBROMETER SYSTEMS AND METHODS FOR DETERMINING OPERATING DEFLECTION SHAPES AND MODE SHAPES BASED ON MEASURED 3D VIBRATIONS OF CURVED STRUCTURE SURFACES

(71) Applicant: University of Maryland, Baltimore County, Baltimore, MD (US)

(72) Inventors: Weidong Zhu, Halethorpe, MD (US); Ke Yuan, Halethorpe, MD (US)

(21) Appl. No.: 18/734,797

(22) Filed: Jun. 5, 2024

Related U.S. Application Data
(60) Provisional application No. 63/506,874, filed on Jun. 8, 2023.
(60) Provisional application No. 63/506,876, filed on Jun. 8, 2023.

(51) Int. Cl. G01M 7/02; G01H 9/00

(52) U.S. Cl. CPC G01M 7/025; G01H 9/00

(57) ABSTRACT

3D continuously scanning laser vibrometer (CSLV) systems and methods for determining operating deflection shapes (ODSs) and mode shapes based on measured 3D vibrations of curved structure surfaces are disclosed. According to an aspect, a system includes first, second, and third laser heads with mirrors configured to be positioned for scanning a curved surface of a structure. The system includes a profile scanner configured to determine a 3D scan trajectory for the curved surface of a structure. Further, the system includes a computing device that controls the first, second, and third laser heads to scan the curved surface of the structure based on the determined 3D scan trajectory. Further, the computing device is configured to measure the 3D vibrations of the curved surface of the structure, and to determine operating deflection shapes and mode shapes of the structure based on the measured 3D vibrations of the curved surface of the structure.

### CROSS REFERENCE TO RELATED APPLICATIONS

This application claims priority to U.S. Provisional Patent Application No. 63/506,874, filed Jun. 8, 2023, and titled MIRROR-ASSISTED 3D CONTINUOUSLY SCANNING LASER DOPPLER VIBROMETRY FOR MEASURING PANORAMIC 3D OPERATING DEFLECTION SHAPES OF A STRUCTURE, and to U.S. Provisional Patent Application No. 63/506,876, filed Jun. 8, 2023, and titled GENERAL-PURPOSE 3D CONTINUOUS SCANNING LASER VIBROMETRY FOR 3D VIBRATION MEASUREMENTS AND MODAL PARAMETER IDENTIFICATION FOR STRUCTURES WITH ARBITRARILY CURVED SURFACES; the contents of which are incorporated herein by reference in their entireties.

### FEDERALLY SPONSORED RESEARCH OR DEVELOPMENT

This invention was made with government support under Federal Grant No. CMMI-1763024, awarded by the National Science Foundation. The government has certain rights to this invention.

### TECHNICAL FIELD

The presently disclosed subject matter relates generally to three-dimensional (3D) continuous scanning laser vibrometry. Particularly, the presently disclosed subject matter relates to 3D continuously scanning laser vibrometer (CSLV) systems and methods for determining operating deflection shapes (ODSs) and mode shapes based on measured 3D vibrations of curved structure surfaces.

### BACKGROUND

3D full-field vibration measurements are significant to structures, especially those with curved and complex surfaces such as turbine blades, vehicle bodies, and aircraft wings. Modal tests that obtain vibration components along three axes of a coordinate system can provide more information and locate defects on more complex structures than those that only obtain single-axis vibration, and can improve the accuracy of their structural health monitoring. 3D full-field vibrations can also be used to identify dynamic characteristics of a complex structure and update its finite element (FE) model during structural analysis and product design where vibration must be determined in all its components. A triaxial accelerometer is a common device in a modal test to capture 3D vibrations of a structure. However, it has some disadvantages as a contact-type sensor, which include the mass loading effect, the tethering problem, and the sensitivity to electromagnetic interference effect. These effects can be amplified when the test structure has light-weight and multiple triaxial accelerometers are needed.

A laser Doppler vibrometer (LDV) was developed to measure vibration of a structure in a non-contact way. A conventional LDV can only capture the velocity response of a fixed point on a structure along a single axis that is parallel to its laser beam. Some investigations focused on extending the conventional LDV to a 3D LDV. Typical ideas include assembling a LDV on an industrial robot arm, moving a LDV to three different locations, and placing three LDVs at three locations and calibrating angles among their laser beams. By orthogonally mounting two scan mirrors in the conventional LDV, a scanning laser Doppler vibrometer (SLDV) was developed to automate modal tests. In one study, an SLDV was placed on a frame with a multi-axis positioning function to extend it to a 3D SLDV system. In another study, a scanning laser head was designed to extend a single LDV to a six-degree-of-freedom system and experimentally validated it by measuring vibration of a 3D structure and identifying its operational deflection shapes. Some investigators developed 3D SLDV systems through moving a single SLDV to three different locations. Commercial 3D SLDV systems, such as Polytec PSV-400 and PSV-500, were developed based on calibration among laser beams from three SLDVs. These 3D SLDV systems have been widely used in engineering, such as 3D vibration measurements of a percussion drill under operating conditions for noise reduction purposes, longitudinal vibration measurement of a beam for damage detection, FE model validation of a sandwich panel and a wind turbine blade, and 3D dynamic strain field measurement of a fan blade. However, it usually takes the 3D SLDV system a long time to obtain high spatial resolution, especially for structures with large surfaces, because laser spots must stay at one measurement point for enough time before they are moved to the next one to conduct more averages of measurement data when high frequency resolution is needed.

A continuously scanning laser Doppler vibrometer (CSLDV) was developed by continuously moving the laser spot along a designed scan path on a structure to save test time. The CSLDV can be used to measure transverse vibration of a structure through one-dimensional (1D) or two-dimensional (2D) scan paths, and dense vibration measured from the CSLDV can be used to detect damage in the structure. There is still a scarcity of studies on 3D vibration measurement of a structure using the CSLDV. Some researchers obtained 3D ODSs of a turbine blade with a curved surface with the CSLDV placed at three different locations. However, it is difficult to ensure that the scan path is the same with the CSLDV placed at the three locations. Also, the 3D vibration measurement system based on the single CSLDV cannot be used to measure transient vibration of a structure and monitor its vibration response in real time. Recently, a novel 3D CSLDV system that consists of three CSLDVs was developed to address the above challenges. The system can focus three laser spots at one location through calibration and direct them to continuously and synchronously scan a pre-designed scan path on a structure. The system was experimentally validated by 3D vibration measurements of a beam and a plate, and ODS and mode shape results showed good agreement with those from a commercial 3D SLDV system and FE models. However, the system function was limited to scanning structures with planar surfaces, such as straight beams and flat plates. In the real world, structures can have curved and complex surfaces.

In view of the foregoing, there is a need for improved 3D laser vibrometer systems and techniques.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a schematic diagram of a 3D CSLDV system for determining operating deflection shapes (ODSs) and mode shapes based on measured 3D vibrations of curved structure surfaces with embodiments of the present disclosure;

FIG. 2 is a flow diagram of an example method for determining ODSs and mode shapes of curved structure surfaces in accordance with embodiments of the present disclosure;

FIG. 3 is another schematic diagram of a 3D CSLDV system in accordance with embodiments of the present disclosure;

FIG. 4A is an image of a reference object used for calibrating three CSLDVs;

FIG. 4B is a schematic diagram of a geometric model of the pair of scan mirrors in a CSLDV;

FIG. 5 is a flow diagram of 3D full-field vibration measurement and 3D ODS identification using a 3D CSLDV system in accordance with embodiments of the present disclosure;

FIG. 6A is an image of an arrangement of the 3D CSLDV system and test blade;

FIG. 6B is an image showing the position of the blade in the measurement coordinate system (MCS);

FIG. 7 depicts profile scanning results of the test blade and its 3D view in the MCS;

FIG. 8 is a graph of the frequency spectrum of the test blade shown as a black solid line and its identified natural frequencies shown as red dashed lines by using the 3D SLDV system;

FIG. 9 depicts a 3D zig-zag scan path designed for 3D CSLDV measurement of the blade;

FIG. 10 are graphs showing input signals for scan mirrors in the top CSLDV;

FIG. 11 are graphs showing input signals for scan mirrors in the left CSLDV;

FIG. 12 are graphs showing input signals for scan mirrors in the right CSLDV;

FIG. 13 are graphs showing transformation from velocities directly obtained by three CSLDVs to those in x, y, and z directions in the MCS with the excitation frequency of 403 Hz;

FIG. 14 are graphs showing transformation from velocities directly obtained by three CSLDVs to those in x, y, and z directions in the MCS with the excitation frequency of 2,226 Hz;

FIGS. 15A and 15B show graphs of 3D full-field ODSs of the turbine blade under sinusoidal excitation from SLDV measurement and CSLDV measurement, respectively, with the excitation frequency of 37 Hz;

FIGS. 16A and 16B show graphs of 3D full-field ODSs of the turbine blade under sinusoidal excitation from SLDV measurement and CSLDV measurement, respectively, with the excitation frequency of 370 Hz;

FIGS. 17A and 17B show graphs of 3D full-field ODSs of the turbine blade under sinusoidal excitation from SLDV measurement and CSLDV measurement, respectively, with the excitation frequency of 403 Hz;

FIGS. 18A and 18B show graphs of 3D full-field ODSs of the turbine blade under sinusoidal excitation from SLDV measurement and CSLDV measurement, respectively, with the excitation frequency of 695 Hz;

FIGS. 19A and 19B show graphs of 3D full-field ODSs of the turbine blade under sinusoidal excitation from SLDV measurement and CSLDV measurement, respectively, with the excitation frequency of 1,870 Hz;

FIGS. 20A and 20B show graphs of 3D full-field ODSs of the turbine blade under sinusoidal excitation from SLDV measurement and CSLDV measurement, respectively, with the excitation frequency of 2,226 Hz;

FIG. 21 is a block diagram of components of an example 3D CSLDV system in accordance with embodiments of the present disclosure;

FIG. 22 is a diagram of orthogonally mounted scan mirrors and their spatial relations with respect to the reference object;

FIG. 23 is a flow diagram having steps of scan mirror signals generated and 3D CSLDV measurement for identification of 3D mode shapes;

FIG. 24 is an image of an experimental setup for testing relative position of the test turbine blade and the 3D CSLDV system and details of the setup of the test turbine blade including its boundary conditions and position in the MCS;

FIG. 25 illustrates graphs showing grid of measurement points and the 3D profile of the surface of the turbine blade;

FIG. 26 is a diagram showing 3D zig-zag scan trajectory pre-designed for the turbine blade to cover its full surface;

FIG. 27 is a diagram showing scan mirror signals for the Top CSLDV based on the 3D zig-zag scan trajectory in FIG. 26;

FIG. 28 is a diagram showing scan mirror signals for the Left CSLDV based on the 3D zig-zag scan trajectory in FIG. 26;

FIG. 29 is a diagram showing scan mirror signals for the right CSLDV based on the 3D zig-zag scan trajectory in FIG. 26;

FIG. 30 illustrates graphs showing transformation from velocities measured in VCSs to three orthogonal components in the defined MCS;

FIG. 31 is a graph showing damped natural frequencies (DNFs) of the turbine blade identified from the frequency spectrum measured by the 3D SLDV system, where the black solid line represents its frequency spectrum and red dashed lines mark its DNFs;

FIG. 32 is a graph showing DNFs of the turbine blade identified from the frequency spectrum measured by the 3D CSLDV system, where the solid line represents its frequency spectrum and dashed lines mark its DNFs;

FIG. 33 are graphs depicting a procedure of identifying the x component of the third 3D full-filed undamped mode shape (FF-UMSs) of the turbine blade under random excitation: section (a) the vibration component in the x direction of the MCS of the turbine blade, section (b) the frequency spectrum of response in section (a), section (c) the frequency spectrum of response filtered by a bandpass filter with a passband of 398 to 400 Hz, where the only peak is the identified DNF of 399 Hz, and section (d) the x component of the third UMS of the turbine blade;

FIG. 34A is a graph showing estimated first full-field damped mode shapes (FF-DMSs) of the turbine blade using the 3D SLDV system;

FIG. 34B is a graph showing corresponding FF-UMSs using the 3D CSLDV system;

FIG. 35A is a graph showing estimated second FF-DMSs of the turbine blade using the 3D SLDV system;

FIG. 35B is a graph showing corresponding FF-UMSs using the 3D CSLDV system;

FIG. 36A is a graph showing estimated third FF-DMSs of the turbine blade using the 3D SLDV system;

FIG. 36B is a graph showing corresponding FF-UMSs using the 3D CSLDV system;

FIG. 37A is a graph showing estimated fourth FF-DMSs of the turbine blade using the 3D SLDV system;

FIG. 37B is a graph showing corresponding FF-UMSs using the 3D CSLDV system;

FIG. 38A is a graph showing estimated fifth FF-DMSs of the turbine blade using the 3D SLDV system;

FIG. 38B is a graph showing corresponding FF-UMSs using the 3D CSLDV system;

FIG. 39A is a graph showing estimated sixth FF-DMSs of the turbine blade using the 3D SLDV system;

FIG. 39B is a graph showing corresponding FF-UMSs using the 3D CSLDV system; and

FIG. 40 is an image that shows details of the reference object and points marked by circles for calibration purposes.

### SUMMARY

The presently disclosed subject matter relates to 3D continuously scanning laser vibrometer (CSLV) systems and methods for determining operating deflection shapes (ODSs) and mode shapes based on measured 3D vibrations of curved structure surfaces. According to an aspect, a system includes first, second, and third laser heads with mirrors configured to be positioned for scanning a curved surface of a structure. The system also includes a profile scanner configured to determine a 3D scan trajectory for the curved surface of a structure. Further, the system includes a computing device operably connected to the first, second, and third laser heads. The computing device is configured to control the first, second, and third laser heads to scan the curved surface of the structure based on the determined 3D scan trajectory. Further, the computing device is configured to measure the 3D vibrations of the curved surface of the structure. The computing device is also configured to determine ODSs and mode shapes of the structure based on the measured 3D vibrations of the curved surface of the structure.

According to another aspect, a method includes using a profile scanner to determine a 3D scan trajectory for a curved surface of a structure. The method also includes positioning first, second, and third laser heads for scanning the curved surface of the structure. Further, the method includes controlling the first, second, and third laser heads to scan the curved surface of the structure based on the determined 3D scan trajectory. The method also includes measuring the 3D vibrations of the curved surface of the structure. Further, the method includes determining ODSs and mode shapes of the structure based on the measured 3D vibrations of the curved surface of the structure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Unless otherwise defined, all technical and scientific terms used herein have the same meaning as commonly understood by one of skill in the art. In case of conflict, the present document, including definitions, will control. Various methods and materials are described herein, although methods and materials similar or equivalent to those described herein can be used in practice or testing of the present disclosure. All publications, patents, patent applications, and other references mentioned herein are incorporated by reference in their entirety. The materials, methods, and examples disclosed herein are illustrative only and not intended to be limiting.

Articles “a” and “an” are used herein to refer to one or to more than one (i.e. at least one) of the grammatical object of the article. By way of example, “an element” means at least one element and can include more than one element.

“About” and “approximately” are used to provide flexibility to a numerical range endpoint by providing that a given value may be “slightly above” or “slightly below” the endpoint without affecting the desired result, for example, +/−5%.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The phrase “in one embodiment”, “in an embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the subject disclosure may be readily combined, without departing from the scope or spirit of the present disclosure.

As defined herein, “full-field” can be defined as vibrations of the whole surface of a structure or vibrations along the entire beam length of the structure.

As referred to herein, the term laser vibrometer system should be broadly construed. This system may include 3D continuously scanning laser Doppler vibrometer systems and 3D continuously scanning laser vibrometer systems. Such systems can measure vibration in terms of the velocity or the displacement of a surface. It can do so by employing laser technology using or not using the Doppler shift principle to provide non-contact measurement.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. A user interface can include an input for allowing users to manipulate a computing device, and can include an output for allowing the computing device to present information and/or data, indicate the effects of the user's manipulation, etc.

In accordance with embodiments, systems and methods are provided for 3D full-field vibration measurements of structures, such as those with curved surfaces. Disclosed herein are 3D continuously scanning laser Doppler vibrometer (CSLDV) systems for measuring 3D full-field vibrations of a structure with a curved surface in a non-contact and fast way. 3D CSLDV systems disclosed herein can include three CSLDVs, a profile scanner, and an external controller. Systems have been experimentally validated by measuring 3D full-field vibrations of a turbine blade with a curved surface under sinusoidal excitation and identifying its operating deflection shapes (ODSs). A 3D zig-zag scan path can be utilized for scanning the curved surface of the blade based on results from the profile scanner. Scan angles of mirrors in CSLDVs are adjusted based on relations among their laser beams to focus three laser spots at one location, and direct them to continuously and synchronously scan the proposed 3D scan path. A signal processing method that is referred to as the demodulation method is used to identify 3D ODSs of the blade. In experiments, it took an 3D SLDV system as disclosed herein about 900 seconds to scan 85 measurement points, and the 3D CSLDV system 115.5 seconds to scan 132,000 points, indicating that the 3D CSLDV system proposed in this study is very efficient for measuring 3D full-field vibration of a structure with a curved surface.

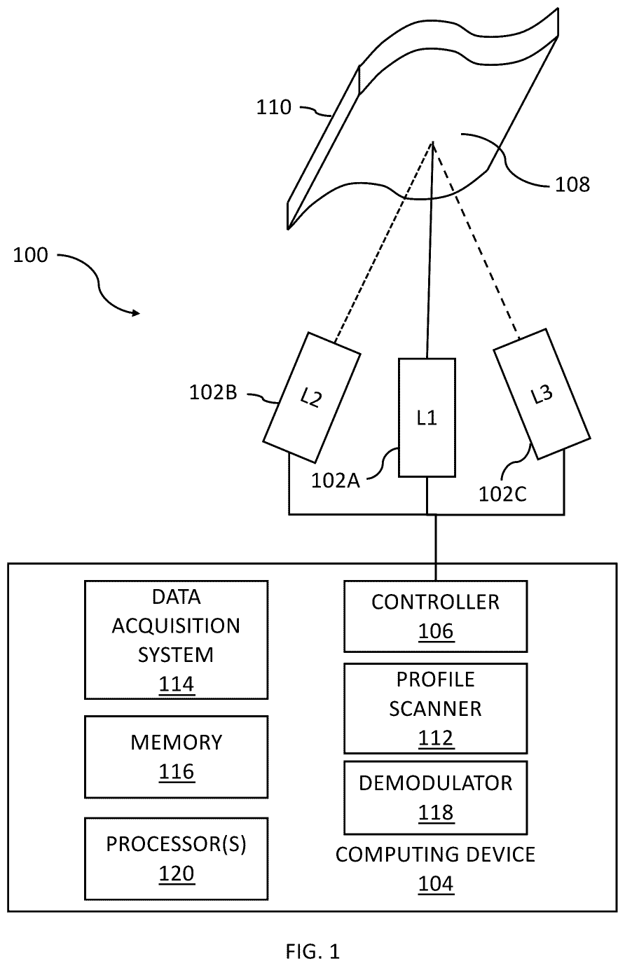

FIG. 1 illustrates a schematic diagram of a 3D CSLDV system 100 for determining ODSs based on measured 3D vibrations of curved structure surfaces with embodiments of the present disclosure. Referring to FIG. 1, the system 100 includes three laser heads 102A, 102B, and 102C (also labeled L1, L2, and L3, respectively), but it should be understood that the system 100 may alternatively include any suitable number of laser heads of suitable type. The system also includes a computing device 104. The computing device 104 includes a controller 106 operatively connected to laser heads 102A, 102B, and 102C for controlling the laser heads to scan a side of a structure 110. Laser heads 102A, 102B, and 102C each include mirrors configured to be positioned for scanning a curved surface 108 on the side of the structure 110.

With continuing reference to FIG. 1, the computing device 104 includes a profile scanner 112 configured to determine a 3D scan trajectory for the curved surface 108 of the structure 110. As described in further detail herein, a 3D scan path can be designed on the curved surface 108 of the structure 110 based on profile scanning, and scan angles of mirrors in laser heads 102A, 102B, and 102C can be adjusted based on relations among vibrometer coordinate systems (VCSs) and the MCS to focus three laser spots at one location, and direct them to continuously and synchronously scan the proposed 3D scan path. Laser heads 102B and 102C can be positioned between about 30 degrees and 60 degrees relative to the laser head 102A. The curved surface 108 can be within a field-of-view (FOV) of laser heads 102A, 102B, and 102C. The controller 106 can control laser heads 102A, 102B, and 102C to scan the curved surface 108 within the FOV for acquiring scan data of the surface. The acquired scan data can be suitably processed by a data acquisition system 114 of the controller 106, and stored in memory 116. In an example, the controller 106 can measure the 3D vibrations of the curved surface 108 based on the acquired scan data.

In accordance with embodiments, the controller 106 can control laser heads 102A, 102B, and 102C to scan the curved surface 108 of the structure 110 based on the determined 3D scan trajectory. Subsequently, the computing device 104 can measure the 3D vibrations of the curved surface 108 of the structure 110.

The computing device 104 can determine ODSs of the structure 110 based on the measured 3D vibrations of the curved surface 108 of the structure 110. More particularly, the computing device 104 can determine ODSs based on the data acquired of the curved surface 108 of the structure 110 within the FOV of laser heads 102A, 102B, and 102C. In embodiments, a demodulator 118 can implement a demodulation method for determining ODSs based on the acquired data.

The controller 106 may be implemented by any suitable hardware, software, and/or firmware. For example, the controller 106 may be implemented by memory 116 and one or more processors 120 of the computing device 104.

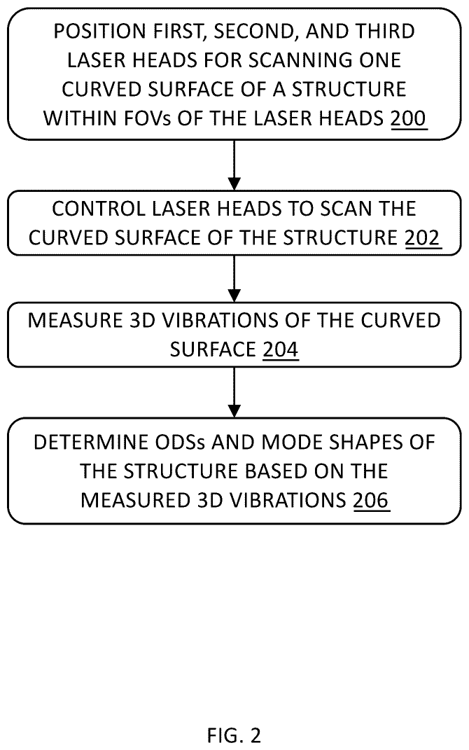

FIG. 2 illustrates a flow diagram of an example method for determining ODSs and mode shapes of curved structure surfaces in accordance with embodiments of the present disclosure. The method of FIG. 2 is described by example as being implemented by the system 100 shown in FIG. 1, but it should be understood that the method may alternatively be implemented by any other suitable system.

Referring to FIG. 2, the method may include using a profile scanner to determine a three-dimensional (3D) scan trajectory for a curved surface of a structure. For example, the profile scanner 112 shown in FIG. 1 can be operated by the computing device 104 to determine a three-dimensional (3D) scan trajectory for a curved surface of a structure. The profile scanner 112 can be used to capture 3D coordinates of points on the curved surface 108 of the structure 110. As an example, the 3D scan trajectory is an approximate zig-zag scan path.

The method of FIG. 2 also includes positioning 200 first, second, and third laser heads for scanning the curved surface of the structure. Continuing the aforementioned example, the computing device 104. Further, the method of FIG. 2 includes controlling 202 the first, second, and third laser heads to scan the curved surface of the structure based on the determined 3D scan trajectory. Continuing the aforementioned example, the computing device 104 can control laser heads 102A, 102B, and 102C to continuously and synchronously move along the same scan trajectory on the curved surface 108 of the structure 110. Prior to scanning, the computing device 104 can use a reference object as a measurement coordinate system (MCS) for calibration. Laser heads 102A, 102B, and 102C can scan the structure under sinusoidal excitation. In an example, the curved surface 108 can be under random excitation.

The method of FIG. 2 includes measuring 204 the 3D vibrations of the curved surface of the structure. Continuing the aforementioned example, the computing device 104 can determine vibration of the structure 110 based on the measured 3D vibrations of the curved surface 108 of the structure 110.

The method of FIG. 2 includes determining 206 operating deflection shapes (ODSs) and mode shapes of the structure based on the measured 3D vibrations of the curved surface of the structure. Continuing the aforementioned example, the demodulator 118 of the computing device 104 can use a demodulation technique to determine the 3D ODSs of the structure 110. As an example, an extended demodulation method (EDM) can be used to estimate damped natural frequencies (DNFs) and 3D full-field undamped mode shapes (FF-UMS) of the structure 110 under random excitation.

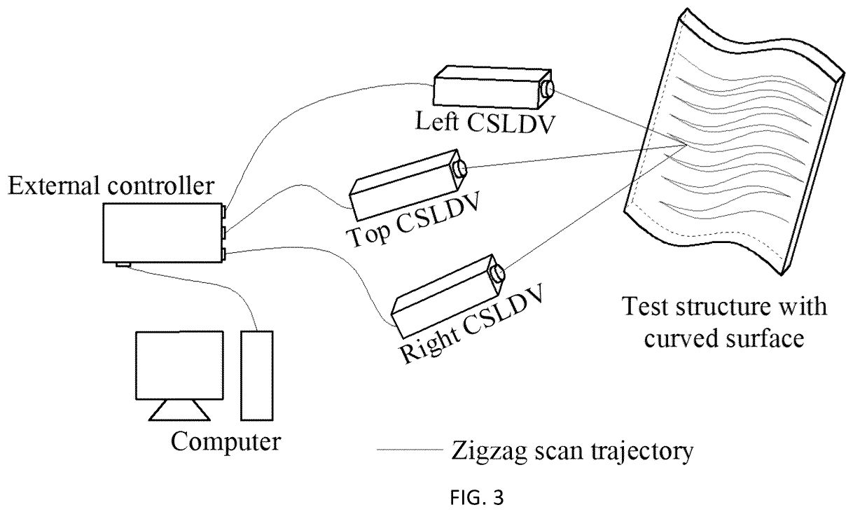

In accordance with embodiments, FIG. 3 illustrates another schematic diagram of a 3D CSLDV system. Referring to FIG. 3, the system top, left, and right CSLDVs for capturing vibration in the 3D CSLDV system. In operation, spatial positions of the three CSLDVs with respect to a reference object can be calculated through a calibration process. A 3D scan path on a curved surface of a test structure can be predesigned based on calibration and profile scanning results, and scan angles of mirrors in CSLDVs can be adjusted based on them to focus three laser spots at one location, and direct them to continuously and synchronously scan the proposed 3D scan path. The developed 3D CSLDV system is extended from the commercial Polytec PSV-500-3D system, which can only conduct step-wise scanning, by connecting an external controller to interface connectors in its three laser heads. The Polytec PSV-500-3D system also has an internal profile scanner that can be used to capture 3D coordinates of points on the test structure. The external controller used to design and generate signals for scan mirrors in this study is a dSPACE MicroLabBox. The 3D CSLDV system and Polytec PSV-500-3D system can be easily switched to each other by connecting or disconnecting the MicroLabBox to the systems.

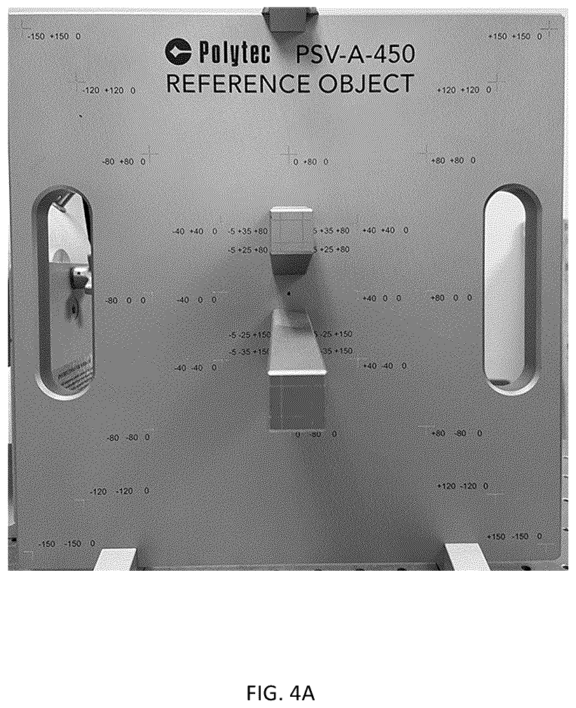

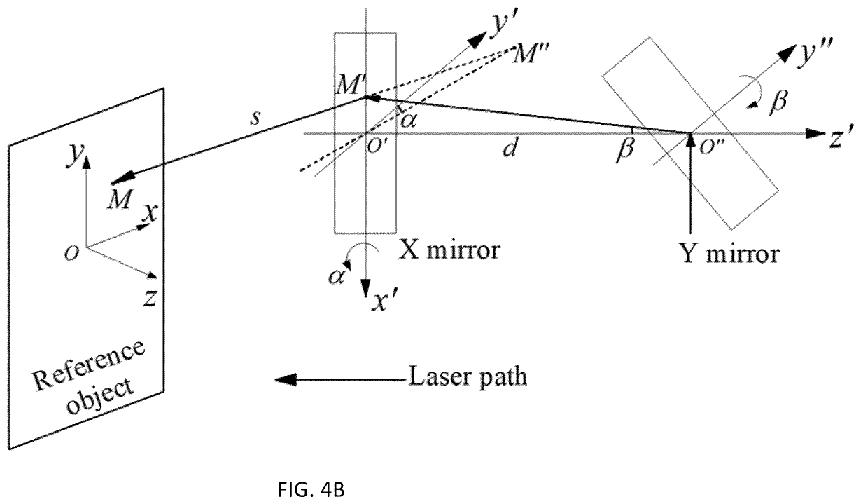

For calibration, the 3D CSLDV system can be calibrated by a reference object with known coordinates that is shown in FIG. 4A, which is an image of a reference object used for calibrating the three CSLDVs. FIG. 4B illustrates a schematic diagram of a geometric model of the pair of scan mirrors in a CSLDV. To determine the location of a CSLDV in the system during measurement, a VCS is created based on its two orthogonal scan mirrors (X and Y mirrors). As shown in 4B, rotating centers of X and Y mirrors, referred to as o′ and o″, respectively, are located along the same axis o′z′ of the VCS o′-x′y′z′ with a separation distance d. Rotating axes of the two scan mirrors are o′x′ and o″y″ axes, respectively, and o″y″ and o′y′ axes are parallel to each other. Rotating angles of X and Y mirrors, α and β, respectively, can be controlled by the external controller. Note that points M′ and o″ on the laser beam path are incident points on X and Y mirrors, respectively. The point o″ is imaged as the point M″ on the plane y′o′z′. For a calibrating point M on the reference object, its coordinates in the MCS M_{MCS}=[x, y, z]^{T} are known, and its coordinates in the VCS can be determined by

$${M}_{VCS} = {[ - d tan ( β ) - s sin ( β ) , - s cos ( α ) cos ( β ) , - s sin ( α ) cos ( β ) ]}^{T} , \qquad ( 1 )$$

where the superscript T represents matrix transpose and s represents the distance between points M and M′. The relation between M_{MCS} and M_{VCS} is determined by using a translation vector T and a direction cosine matrix R:

$${M}_{MCS} = T + R {M}_{VCS} , \qquad ( 2 )$$

where T=[xₒ, yₒ, zₒ] denotes coordinates of the origin of the VCS o′ in the MCS. By solving an optimization problem and an over-determined nonlinear problem [25, 29], T and R matrices for all the three CSLDVs can be calculated.

In some embodiments, an efficient bisection method can be used for designing a straight-line scan path for a beam, and a 2D zigzag scan path for a flat plate. However, the bisection method assumes that all the measurement points are in a plane; so it may not be suitable for 3D CSLDV measurements of structures with curved surfaces. In experiments with the present disclosure, a method is developed to address the challenge and design scan paths on both planar and curved surfaces.

A 3D CSLDV system according to embodiments can include three VCSs and one MCS. A measurement point Mk on the surface of a test structure has constant coordinates in the MCS and different coordinates in three VCSs. Therefore, relations among three CSLDVs based on the point is

$${M}_{MCS}^{k} = {T}_{1} + {R}_{1} {M}_{VCS \_ 1}^{k} = {T}_{2} + {R}_{2} {M}_{VCS \_ 2}^{k} = {T}_{3} + {R}_{3} {M}_{VCS \_ 3}^{k} , \qquad ( 3 )$$

where the superscript k is the sequence number of the measurement point along the scan path, and subscripts 1, 2, and 3 denote Top, Left, and Right CSLDVs, respectively. By Eq. (3), one has

$${M}_{VCS \_ 1}^{k} = {R}_{1}^{- 1} ( {M}_{MCS}^{k} - {T}_{1} ) , \qquad ( 4 )$$

$${M}_{VCS \_ 2}^{k} = {R}_{2}^{- 1} ( {M}_{MCS}^{k} - {T}_{2} ) , \qquad ( 5 )$$

$${M}_{VCS \_ 3}^{k} = {R}_{3}^{- 1} ( {M}_{MCS}^{k} - {T}_{3} ) . \qquad ( 6 )$$

Based on calculated coordinates of the point Mk in VCSs, rotating angles of scan mirrors in the three CSLDVs are

$${α}_{1}^{k} = arctan ( {z}_{VCS \_ 1}^{k} / {y}_{VCS \_ 1}^{k} ) {β}_{1}^{k} = arctan ( {x}_{VCS \_ 1}^{k} / ( {y}_{VCS \_ 1}^{k} / cos ( {α}_{1}^{k} ) - d ) ) , \qquad ( 7 )$$

$${α}_{2}^{k} = arctan ( {z}_{VCS \_ 2}^{k} / {y}_{VCS \_ 2}^{k} ) {β}_{2}^{k} = arctan ( {x}_{VCS \_ 2}^{k} / ( {y}_{VCS \_ 2}^{k} / cos ( {α}_{2}^{k} ) - d ) ) , \qquad ( 8 )$$

$${α}_{3}^{k} = arctan ( {z}_{VCS \_ 3}^{k} / {y}_{VCS \_ 3}^{k} ) {β}_{3}^{k} = arctan ( {x}_{VCS \_ 3}^{k} / ( {y}_{VCS \_ 3}^{k} / cos ( {α}_{3}^{k} ) - d ) ) , \qquad ( 9 )$$

respectively.

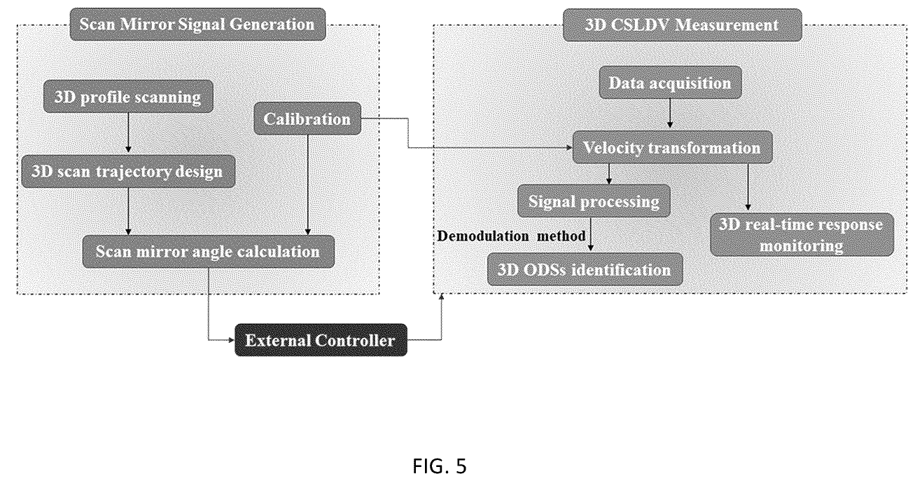

As discussed above, an important factor to calculate rotation angles of scan mirrors in the three CSLDVs is to obtain exact (or approximate) coordinates of each measurement point on the scan path in the MCS. Although a device like a 3D scanner can be used to easily obtain the profile of a structure, the Polytec PSV-500-3D system is used in this work to scan the test structure and obtain 3D coordinates of points on its surface, which can reduce possible errors from interaction between the scanner and 3D CSLDV system. Note that a linear interpolation is used to process the obtained surface profile, since the Polytec PSV-500-3D system can only move laser spots in a step-wise mode along a pre-defined grid that is not dense enough to generate signals for CSLDV measurement. Velocity transformation based on the point is

$${[ {V}_{x}^{k} , {V}_{y}^{k} , {V}_{z}^{k} ]}^{T} = {{[ {[ {R}_{1} {e}_{1}^{k} , {R}_{2} {e}_{2}^{k} , {R}_{3} {e}_{3}^{k} ]}^{T} ]}^{- 1} [ {V}_{1}^{k} , {V}_{2}^{k} , {V}_{3}^{k} ]}^{T} , \qquad ( 10 )$$

where subscripts x, y, and z denote calculated velocity components in corresponding directions, respectively; subscripts 1, 2, and 3, and the superscript k have the same meanings as herein; and the vector e=[sin (β), cos (α) cos (β), sin (α) cos (β)]^{T} denotes the unit vector of the laser path between points M and M′ that is shown in FIG. 4B. By repeating the above transformation at each point along the designed scan path on the test structure, its 3D full-field vibration can be finally obtained in the MCS. The obtained response can not only be directly used to monitor real-time 3D vibration of the test structure, but also be processed to identify its 3D ODSs. Steps for measuring 3D full-field vibration of a structure with a curved surface by the 3D CSLDV system described above can be schematized FIG. 5, which illustrates a flow diagram of 3D full-field vibration measurement using a system in accordance with embodiments of the present disclosure.

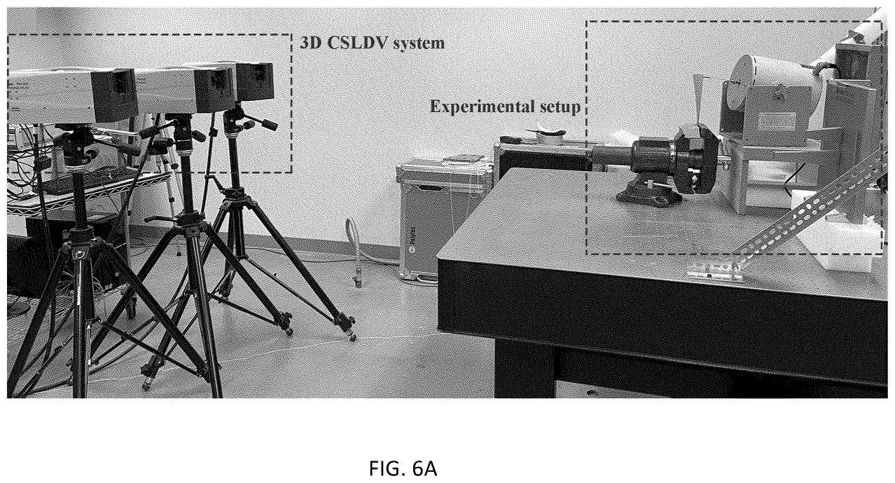

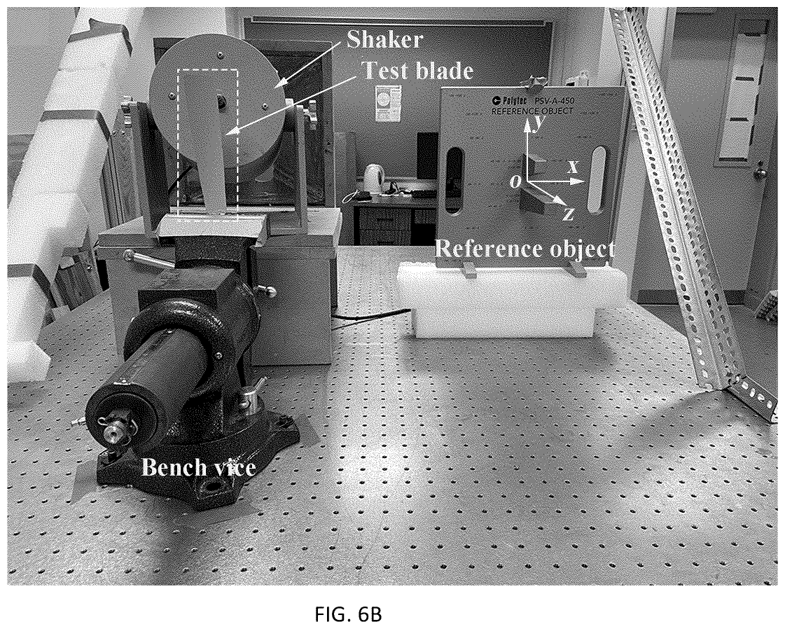

A turbine blade twisted from a trapezoidal plate was used as the test structure in this work. The original trapezoidal plate had two bases of 26 mm and 42 mm, an altitude of 173.9 mm, and a thickness of 3.5 mm. The blade with a curved surface was clamped at its one end by a bench vice to simulate clamped-free boundary conditions, and excited by a MB Dynamics MODAL-50 shaker at its top end through a stinger, as shown in FIGS. 6A and 6B. FIG. 6A is an image of an arrangement of the 3D CSLDV system and test blade, and FIG. 6B is an image showing the position of the blade in the MCS. A grey reflective tape was attached on the surface of the blade to maximize back-scattering of laser light. In the experiment, the MCS was set as parallel to the clamped end of the blade (FIG. 6B), so that the z direction represents the out-of-plane component of vibration of the blade, and x and y directions represent its in-plane components. Sinusoidal excitations with different frequencies were used in this study to obtain ODSs of the blade.

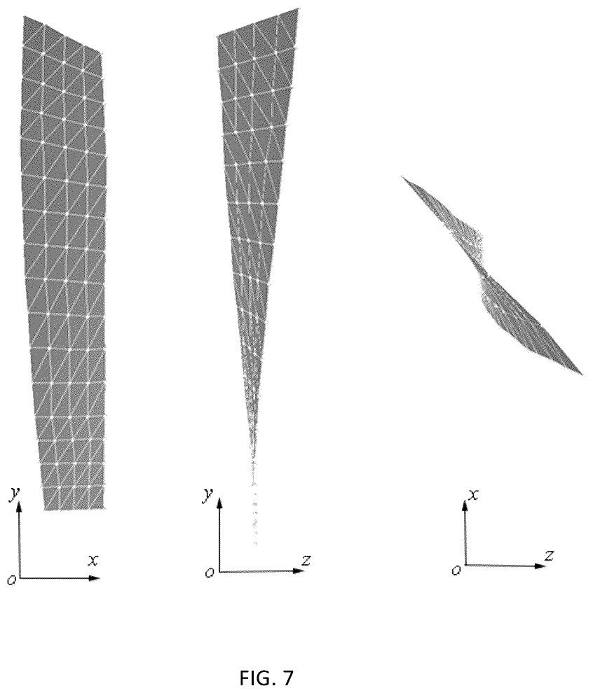

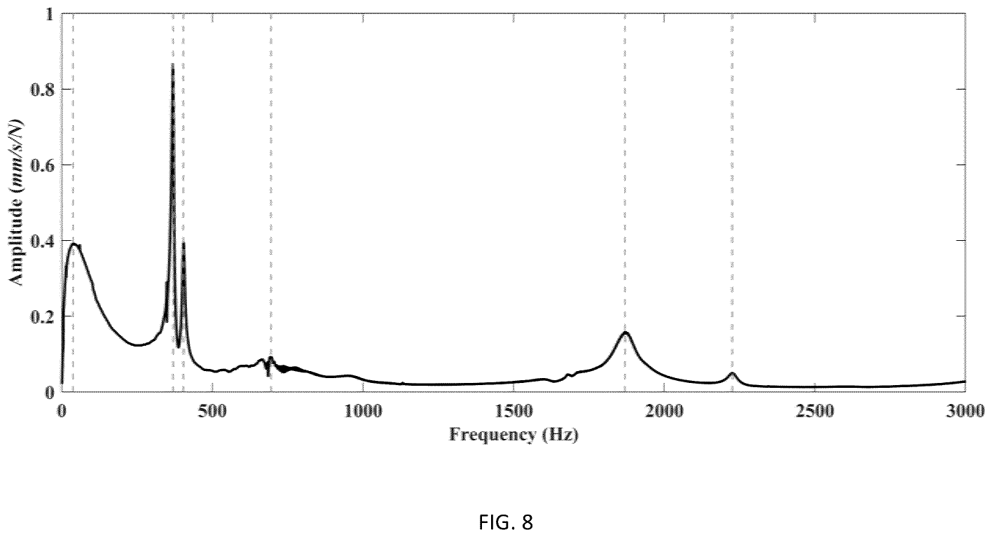

In experiments, a profile scanning procedure was conducted prior to the scan path design. A total of 85 scanning points were arranged as a 17×5 grid, which were also used as measurement points in 3D SLDV measurement and reference points in comparison with CSLDV measurement results. The 3D view of the blade profile is shown in FIG. 7, which are depictions of profile scanning results of the test blade and its 3D view in the MCS. The frequency spectrum of the blade obtained from 3D SLDV measurement is shown in FIG. 8 as a black solid line. FIG. 8 is a graph of frequency spectrum of the test blade shown as a black solid line and its identified natural frequencies shown as red dashed lines by using the 3D SLDV system. The first six natural frequencies of the blade, which are 37.5 Hz, 370.5 Hz, 403.3 Hz, 695.1 Hz, 1,870.8 Hz, and 2,226.3 Hz, are identified in the frequency range from 0 to 3,000 Hz and marked by dashed lines. 3D SLDV and CSLDV measurements of the blade under sinusoidal excitations were conducted in the experiment, where excitation frequencies are close to its first six natural frequencies.

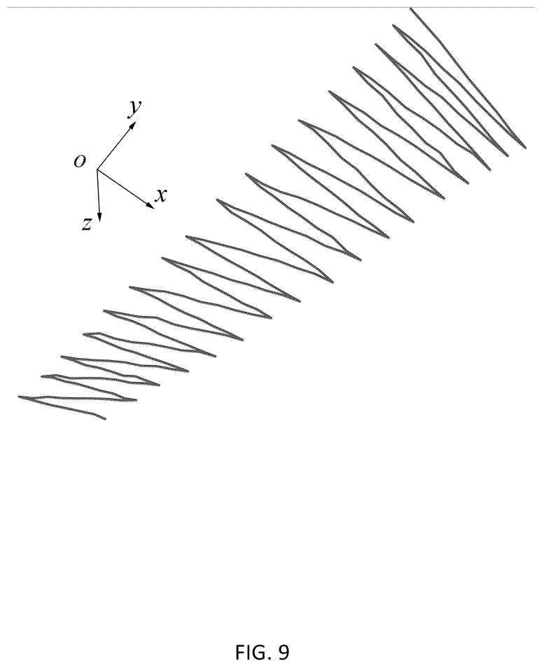

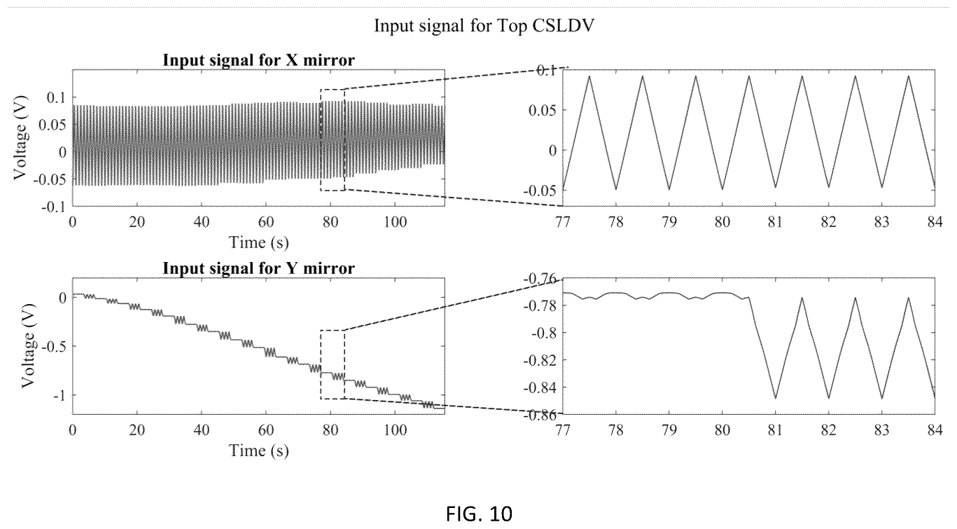

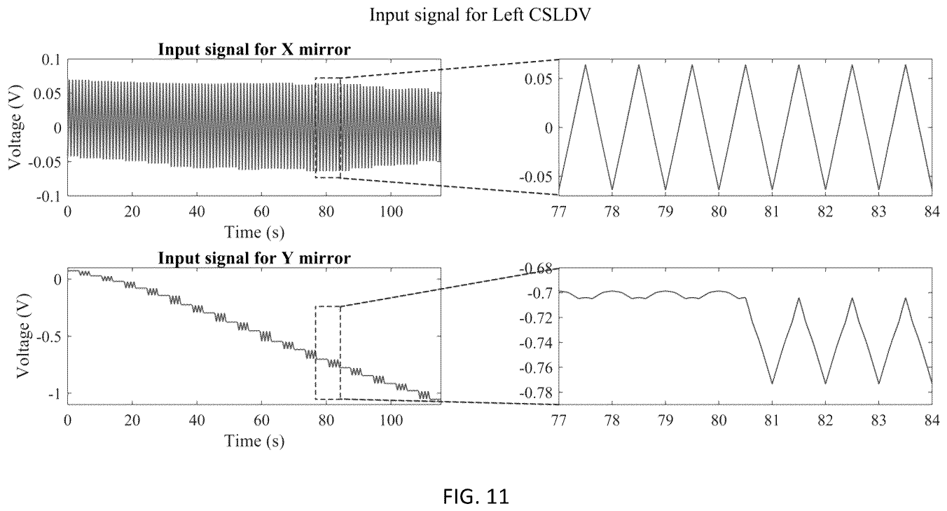

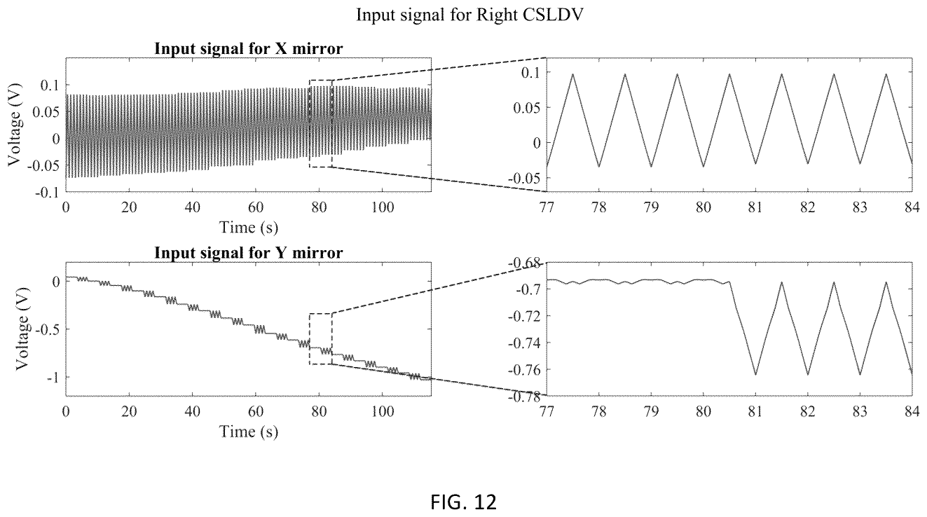

Based on profile scanning data and the linear interpolation method, a 3D zig-zag scan path, which includes 33 scan lines, as shown in FIG. 9, was designed for 3D CSLDV measurement of the blade, and coordinates of each point on the scan path were calculated in the MCS. FIG. 9 depicts a 3D zig-zag scan path designed for 3D CSLDV measurement of the blade. A scanning period T can be defined as a cycle that laser spots move along a scan line from the start point to the end point and move back. The scanning frequency ƒ_{sca}=1/T. In the experiment, ƒ_{sca}=1 Hz, and laser spots were designed to move along each scan line with 3.5 periods to ensure continuity of the whole zig-zag scan path and obtain enough response data to conduct a three-time average, which is the same as that for 3D CSLDV measurement. Therefore, the total time of scanning the whole blade surface in 3D CSLDV measurement is 1=33×3.5×1=115.5s. Signals generated for the three CSLDVs are shown in FIG. 10-12, where two cycles of each signal series are amplified and shown in right subplots. Particularly, FIG. 10 are graphs showing input signals for scan mirrors in the top CSLDV, FIG. 11 are graphs showing input signals for scan mirrors in the left CSLDV, and FIG. 12 are graphs showing input signals for scan mirrors in the right CSLDV. One can see that signals for X mirrors are close to triangular waves, while those for Y mirrors are curved, which are much different from those used for 3D CSLDV measurements of a straight beam and a flat plate.

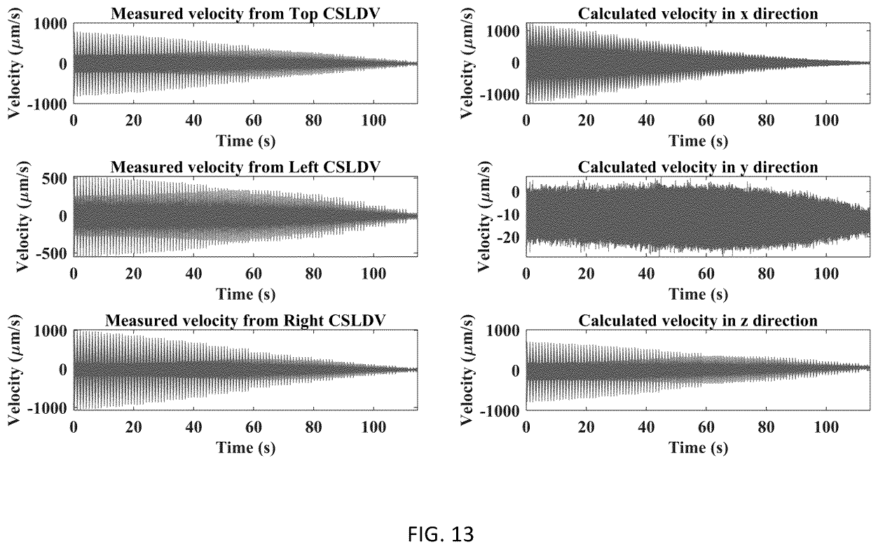

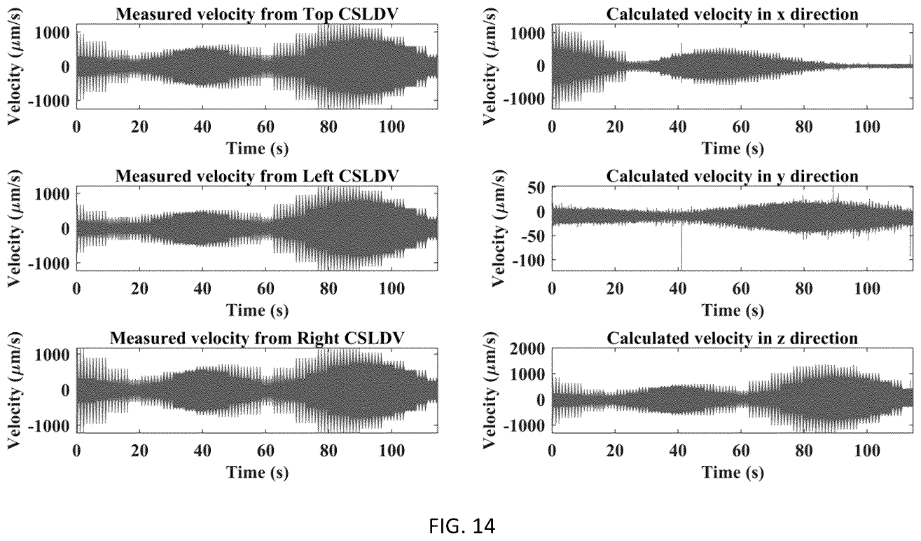

Vibration of the blade in three VCSs can be directly obtained from 3D CSLDV measurement, while vibration components in the MCS can be obtained through velocity transformation using Eq. (10). In order to indicate the velocity transformation procedure, the original and calculated vibration responses from 3D CSLDV measurements of the blade under sinusoidal excitations with excitation frequencies of 403 Hz and 2,226 Hz are used as two examples, as shown in FIGS. 13 and 14, respectively, where horizontal axes represent time and vertical axes represent velocities. FIG. 13 are graphs showing transformation from velocities directly obtained by three CSLDVs to those in x, y, and z directions in the MCS with the excitation frequency of 403 Hz. FIG. 14 are graphs showing transformation from velocities directly obtained by three CSLDVs to those in x, y, and z directions in the MCS with the excitation frequency of 2,226 Hz. In each figure, the three left subplots show original velocities from the three CSLDVs, and the three right subplots show calculated velocities in three axes of the MCS. In the experiment, laser spots were moved to scan the surface of the blade from its upper end to its lower end; so time-velocity series shown in the two figures represent responses from its free end to its clamped end. One can see that original time-velocity series from the three CSLDVs have similar shapes to each other and to calculated velocities in the z direction in the MCS. This is the case because each 1D CSLDV is designed to measure the single-axial velocity along the direction of its laser beam, which is close to the z direction in the experiment. It can also be found that velocities around lower ends of the blade are much smaller than those in other areas, and velocities in the y direction have much smaller amplitudes than those in x and z directions, which are in agreement with theoretically predicted results due to clamped-free boundary conditions of the blade in the experiment.

In experimentation, a demodulation method was used to process the steady-state response of the blade from 3D CSLDV measurement under sinusoid excitation to obtain its 3D ODSs at various excitation frequencies. The steady-state response u of the blade can be written as

$$u ( x , t ) = U ( x ) cos ( ω t - φ ) = {U}_{I} ( x ) cos ( ω t ) + {U}_{Q} ( x ) sin ( ω t ) \qquad ( 11 )$$

using the method of separation of variables, where x and t represent position and time information of measurement points, respectively, φ and ω are the phase and excitation frequency, respectively, and U(x) are responses at measurement points that contain in-phase component U₁(x) and quadrature component U_{Q} (x). Multiplying u(x,t) by cos (ωt) and sin (ωt) yield

$$\begin{matrix}u ( x , t ) cos ( ω t ) = {Φ}_{I} ( x ) {cos}^{2} ( ω t ) + {Φ}_{Q} ( x ) sin ( ω t ) cos ( ω t ) \\ = \frac{1}{2} {Φ}_{I} ( x ) + \frac{1}{2} {Φ}_{I} ( x ) cos ( 2 ω t ) + \frac{1}{2} {Φ}_{Q} ( x ) sin ( 2 ω t ) ,\end{matrix} \qquad ( 12 )$$

$$\begin{matrix}u ( x , t ) sin ( ω t ) = {Φ}_{I} ( x ) sin ( ω t ) cos ( ω t ) + {Φ}_{Q} ( x ) {sin}^{2} ( ω t ) \\ = \frac{1}{2} {Φ}_{Q} ( x ) + \frac{1}{2} {Φ}_{I} ( x ) sin ( 2 ω t ) - \frac{1}{2} {Φ}_{Q} ( x ) cos ( 2 ω t ) ,\end{matrix} \qquad ( 13 )$$

respectively, where sin (2ωt) and cos (2ωt) terms can be eliminated by a low-pass filter, and U₁ (x) and U_{Q} (x) can be obtained by multiplying filtered responses by a scale factor of two, respectively.

The sampling frequency of 3D CSLDV measurement in the experiment is ƒₛₐ=8,000 Hz, which is about 3.5 times the sixth natural frequency of the blade shown in FIG. 8 and can cover the frequency range of interest of the blade. The number of sampling points on each scan line of the 3D zig-zag scan path in this study can be obtained using ƒ_{sc} and ƒₛₐ via

$${k}_{each} = 0.5 \times \frac{1}{{f}_{sc}} \times {f}_{sa} = 0.5 \times 1 \times 8 , 000 = 4 , 0. \qquad ( 14 )$$

Therefore, there are a total of 132,000 measurement points on 33 scan lines along the scan path shown in FIG. 9. The test time of CSLDV measurement is determined by its scanning frequency, number of scanning periods, and density of the scan path. The test time of traditional SLDV measurement is determined by its number of measurement points, frequency resolution, and number of averages. Moreover, it takes some time to move laser spots from one measurement point to the next one. Comparison between the number of measurement points of 3D CSLDV measurement and that of 3D SLDV measurement is shown in the second column in Table 1, and corresponding comparison of the test time is shown in the third column in Table 1. One can see that the number of measurement points in 3D CSLDV measurement is about 1,500 times of that in 3D SLDV measurement, while the test time in 3D CSLDV measurement is less than ⅛ of that in 3D SLDV measurement, meaning that the proposed 3D CSLDV system is much more efficient in 3D full-field vibration measurement than the 3D SLDV system.

TABLE 1
Comparisons between the number of measurement
points and test time of 3D CSLDV measurement
and those of 3D SLDV measurement

| Measurement system | Number of measurement points | Test time (s) |
|---|---|---|
| 3D CSLDV system | 132,000 | 115.5 |
| 3D SLDV system | 85 | 900 |

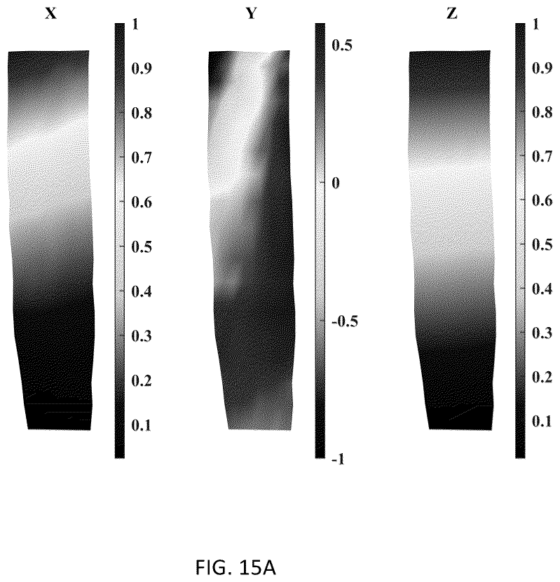

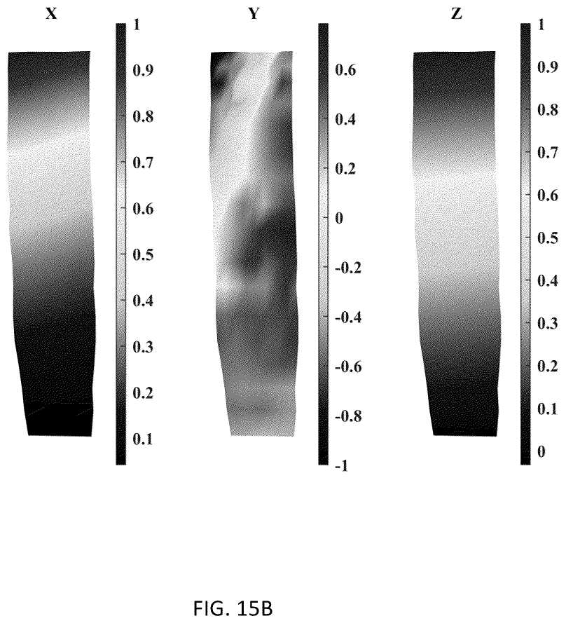

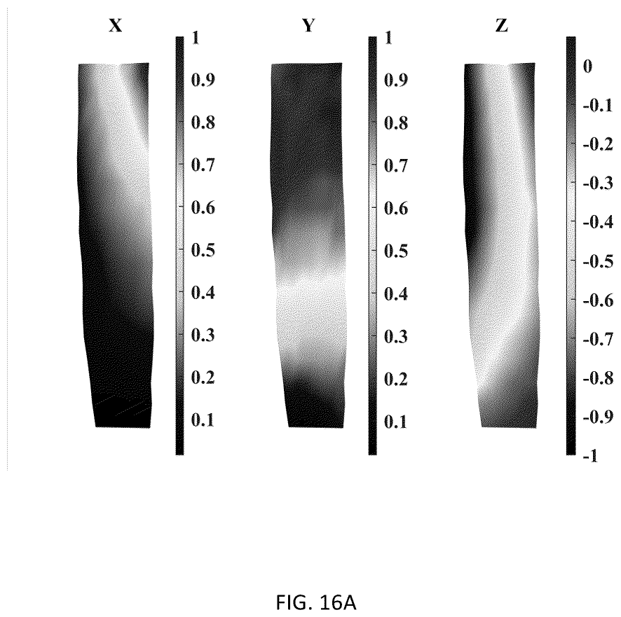

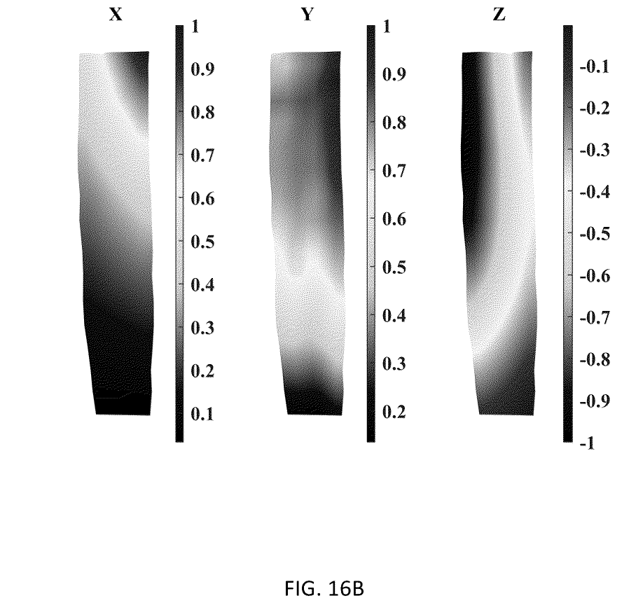

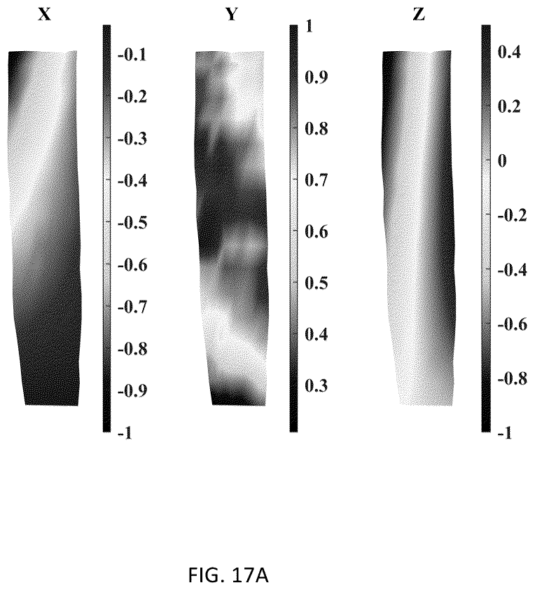

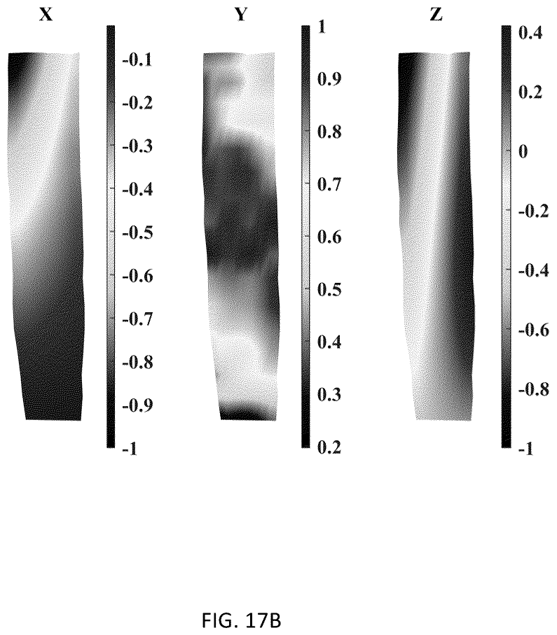

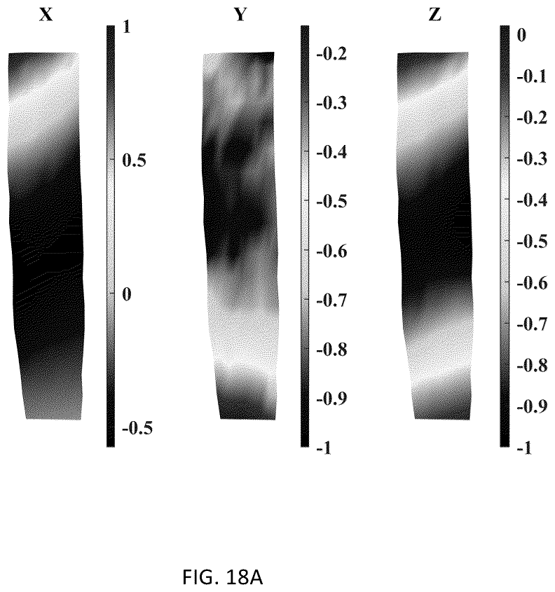

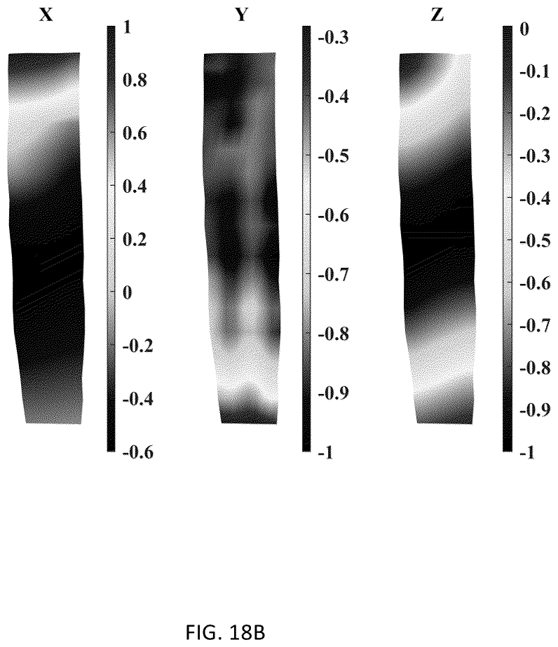

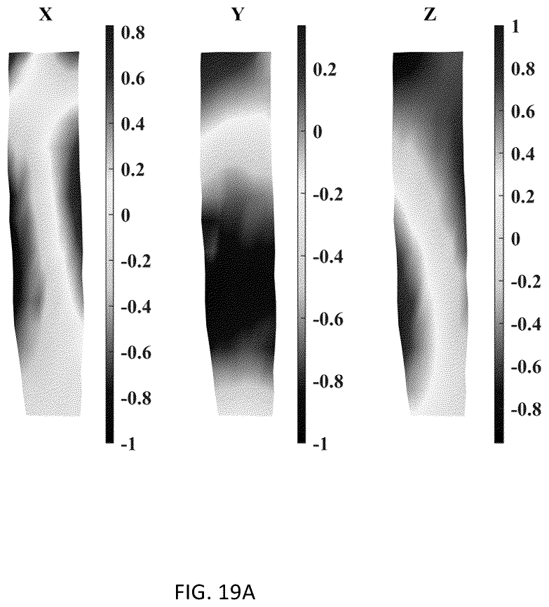

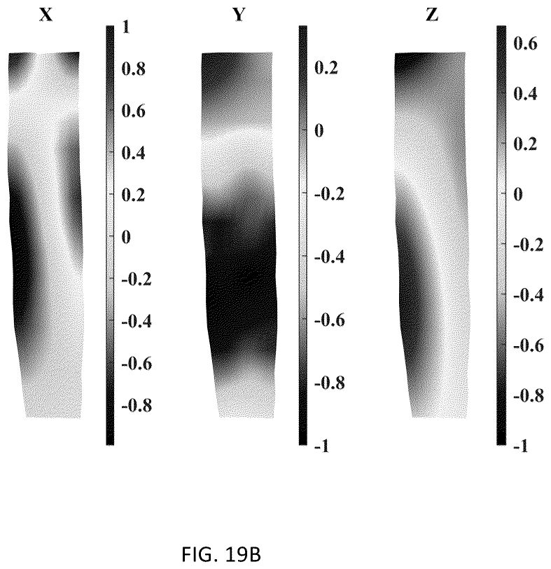

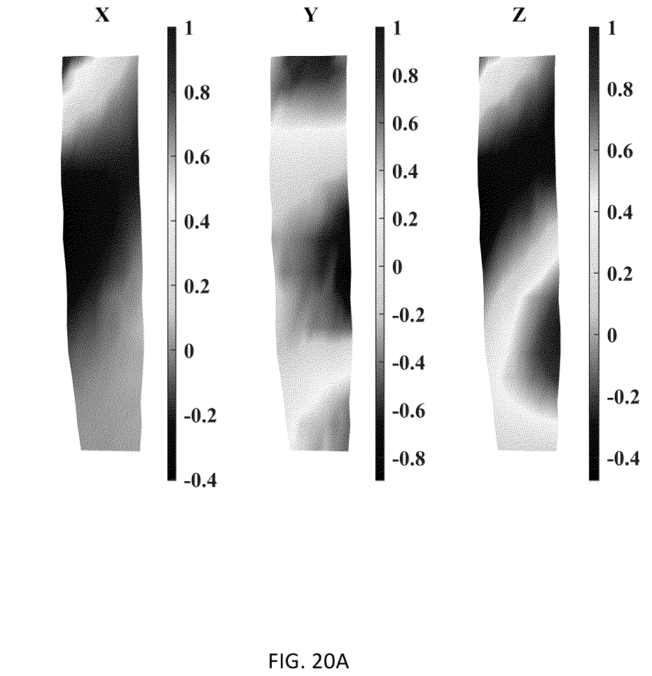

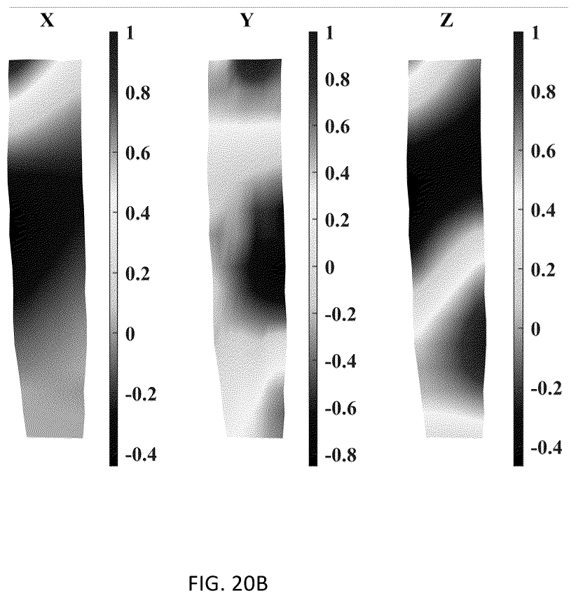

Results of the first six 3D full-field ODSs of the clamped-free blade at six excitation frequencies that are 37 Hz, 370 Hz, 403 Hz, 695 Hz, 1,870 Hz, and 2,226 Hz from 3D SLDV and 3D CSLDV measurements are normalized with unit maximum absolute component values, as shown in FIGS. 15A-20B, where left subplots represent ODSs from SLDV measurement and right subplots represent ODSs from CSLDV measurement. In each subplot, ODSs from x, y, and z directions defined by the MCS are shown from left to right. One can see that the 1^{st}, 4^{th}, and 6^{th} ODSs from CSLDV measurement are bending modes while the 2^{nd}, 3^{rd}, and 5^{th} ODSs are torsional modes, which have similar patterns to those from corresponding SLDV measurement. It can also be found that ODSs from CSDLV measurement are smoother than those from SLDV measurement, especially for those with higher excitation frequencies, since there are much more measurement points in CSLDV measurement than those in SLDV measurement. Note that ODSs in the y direction are less smooth than those in x and z directions for both SLDV and CSLDV measurements. The possible reason is that longitudinal vibration is harder to be excited than transverse vibration for a cantilever structure, which leads to smaller signal-to-noise ratios (SNRs) in the y direction than those in x and z directions; this can also be validated from 3D real-time responses shown in FIGS. 13 and 14.

To further check correlations between 3D full-field ODSs of the turbine blade from 3D SLDV and 3D CSLDV measurements, their MAC values are listed in Table 2, for all the six modes in three directions, one can see that the minimum MAC value is 95%, showing high correlations between results from the commercial 3D SLDV system and proposed 3D CSLDV system. It can be safely concluded that accuracy of the commercial 3D SLDV system and proposed 3D CSLDV system are at the same level.

TABLE 2
MAC values between 3D full-field ODSs of the turbine
blade under sinusoidal excitations from 3D SLDV
measurement and those from 3D CSLDV measurement

| | MAC values | | |
|---|---|---|---|
| Mode No. | x | y | z |
| 1 | 99.9% | 95.2% | 99.9% |
| 2 | 95.6% | 97.7% | 98.3% |
| 3 | 99.6% | 99.4% | 97.3% |
| 4 | 97.1% | 98.0% | 99.5% |
| 5 | 95% | 99.4% | 96.4% |
| 6 | 95.4% | 96.9% | 96.6% |

3D CSLDV systems as disclosed herein have been experimentally validated through 3D vibration measurement and modal parameter identification of a turbine blade with a curved surface under sinusoidal excitation. Calibration among three VCSs built on the three CSLDVs and a MCS built on a reference object is conducted to obtain their relations. A 3D zig-zag scan path is proposed based on profile scanning, and scan angles of CSLDVs are adjusted based on relations among VCSs and the MCS to focus three laser spots at one location, and direct them to continuously and synchronously scan the proposed 3D scan path. By using sinusoidal excitations with frequencies in the range from 0 to 3,000 Hz to excite the blade, six 3D full-field ODSs of the blade are obtained. Comparison between the first six ODSs from 3D SLDV measurement and those from 3D CSLDV measurement is made in this study. The minimum MAC value between them is 95%, meaning that the proposed 3D CSLDV system has the same accuracy as that of the commercial 3D SLDV system. In the experiment, the number of measurement points in 3D CSLDV measurement is about 1,500 times of that in 3D SLDV measurement, while the test time in 3D CSLDV measurement is less than ⅛ of that in 3D SLDV measurement, meaning that the 3D CSLDV system is much more efficient than the 3D SLDV system for measuring 3D full-field vibrations of a structure with a curved surface.

Extending the disclosed methodology to estimate 3D mode shapes a structure with a curved surface under random excitation, which is a practical excitation method, where development of an extended demodulation method for handling response of a structure under random excitation and enhancement of SNRs of measured response of the structure would be foreseeable challenges. In addition, the field of view of a structure with a large curvature, such as a ball and sphere, can be a common challenge in its vibration measurement using an LDV. The problem can be resolved by using a mirror to extend the field of view so that even vibration of the back side of the structure can be measured without moving the structure or the LDV. The 3D CSLDV system and its calibration and scan path design methods disclosed herein are applicable to vibration measurements of a ball and a sphere once coordinates of their measurement points are obtained.

In accordance with embodiments, modal parameters of a turbine blade with a curved surface excited by white noise can be identified by 3D CSLDV systems via an extended demodulation method (EDM) as disclosed herein. The disclosed systems can be calibrated to synchronously and continuously move three laser spots on the curved surface of the blade along the same scan trajectory and capture its 3D vibrations. The EDM can be used to estimate its damped natural frequencies (DNFs) and 3D FF-UMS. Identified modal parameters are compared with those from a commercial 3D scanning laser Doppler vibrometer (SLDV) system. Differences between their first six DNFs are less than 1.5%; their first six mode shapes are highly correlated as their modal assurance criterion values all exceed 95%. However, 3D CSLDV systems as disclosed herein have much higher efficiency in obtaining 3D mode shapes of the blade than the 3D SLDV system.

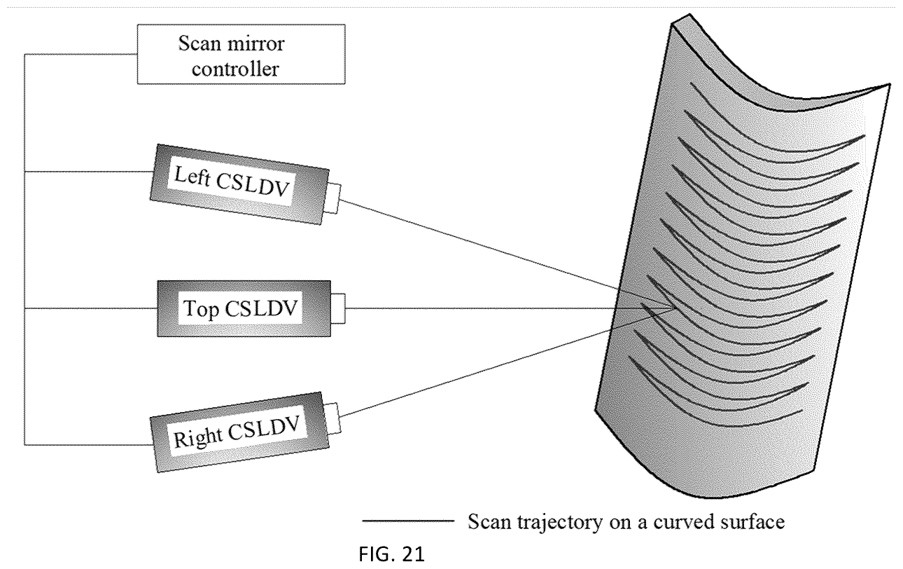

FIG. 21 illustrates a block diagram of components of an example 3D CSLDV system in accordance with embodiments of the present disclosure. Referring to FIG. 21, the system includes three laser heads, which can be referred to as top, left, and right CSLDVs. Example laser heads include Polytec PSV-500 3D SLDV systems and can be used for vibration data acquisition. A controller can be integrated with the 3D SLDV system that only has a step scanning function to conduct a continuously scanning mode. Spatial relations among three CSLDVs can be determined using a reference object via a calibration procedure and used with the 3D profile of a test structure to pre-design a 3D full-field trajectory to scan its curved surface. Input signals of scan mirrors with respect to the scan trajectory can make three laser spots to scan it in a synchronous and continuous mode.

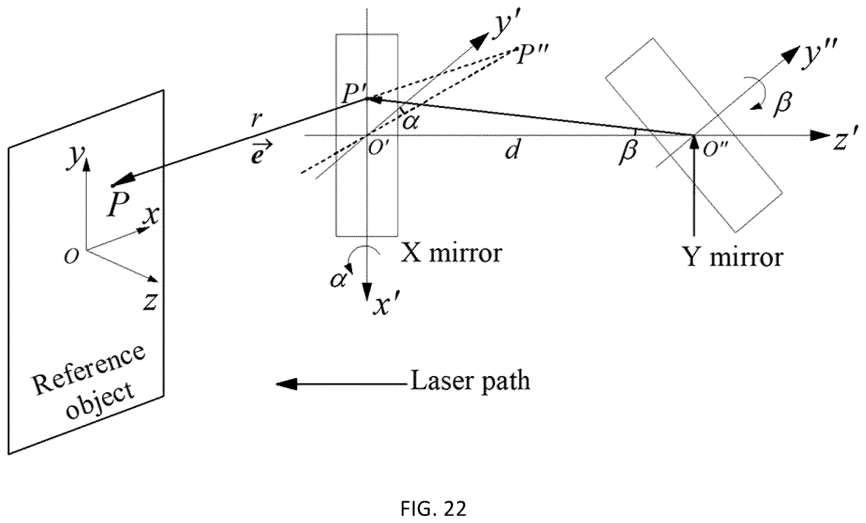

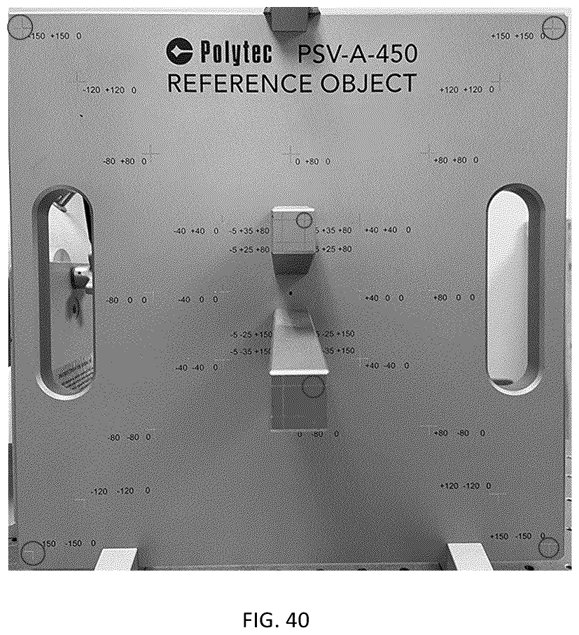

An MCS can be built using a reference object, as shown in FIG. 40, which can provide multiple calibration points with known coordinates. In this example, there are twenty-one points on the plane of the reference object and eight points on its two poles. Three VCSs of three CSLDVs are based on their respective orthogonally mounted scan mirrors, whose geometrical model can be seen in FIG. 22, which illustrates a diagram of orthogonally mounted scan mirrors and their spatial relations with respect to the reference object. X and Y mirrors rotate about orthogonal axes o′x′ and o″y″, respectively, and both of their rotating centers, o′ and o″, are on o′z′, whose separation distance is d. The point p″ is the virtual image of the point o″, which means that |o′P″|=|o′o″|=d. The generated laser beam passes through X and Y mirrors at incident points P′ and o″, respectively. The distance between the point P′ and a point P on the reference object is r. In the VCS, coordinates of points P′ and P″ are written as

$${P}_{VCS}^{′} = {[ - d tan ( β ) , 0 , 0 ]}^{T} , \qquad ( 15 )$$

$${P}_{VCS}^{″} = {[ 0 , d cos ( α ) , d sin ( α ) ]}^{T} , \qquad ( 16 )$$

respectively, where α and β denote rotating angles of X and Y mirrors, respectively, and the subscript T denotes transpose of a matrix. The unit vector of PP′ can be derived by

$$\begin{matrix}e = \frac{{P}^{′} {P}^{″}}{\vert {P}^{′} {P}^{″} \vert} \\ = {\frac{1}{d \sqrt{{tan}^{2} ( β ) + 1}} [ d tan ( β ) , d cos ( α ) , d sin ( α ) ]}^{T} \\ = {[ sin ( β ) , cos ( α ) cos ( β ) , sin ( α ) cos ( β ) ]}^{T} .\end{matrix} \qquad ( 17 )$$

Coordinates of a selected calibration point P on the reference objective can be written using the VCS as

$$\begin{matrix}{P}_{VCS} = {P}_{VSC} - re \\ = {[ - d tan ( β ) , 0 , 0 ]}^{T} - {r [ sin ( β ) , cos ( α ) cos ( β ) , sin ( α ) cos ( β ) ]}^{T} \\ = {[ - d tan ( β ) - r sin ( β ) , - r cos ( α ) cos ( β ) , - r sin ( α ) cos ( β ) ]}^{T} ,\end{matrix} \qquad ( 18 )$$

The relation between coordinates of P in the MCS P_{MCS} and VCS P_{VCS} can be written as

$${P}_{MCS} = T + {RP}_{VCS} , \qquad ( 19 )$$

where P_{MCS}=[x, y, z]^{T} can be directly read from the reference object, T=[xₒ, yₒ, zₒ]^{T} denotes coordinates of o′ in the MCS, and R is the direction cosine matrix from the MCS to the VCS. Three pairs of T and R matrices for the system can be calculated y using a method that includes procedures of solving an over-determined nonlinear problem and an optimization problem, three pairs of T and R matrices for the system can be calculated.

A multi-bisection method based on an assumption of a planar geometry may be used in scan trajectory designs for a straight beam and a flat plate. Although the method is efficient, it is not suitable for scan trajectory designs for structures with curved surfaces. To address the above challenge, a method for designing 3D scan trajectories is developed for general surfaces, including both planar and curved ones.

Three VCSs and one MCS have been introduced. Since a measurement point P^{k} in the MCS has the same coordinates, their coordinates in three VCSs are different. Therefore, one has

$${P}_{MCS}^{k} = {T}_{1} + {R}_{1} {P}_{VCS \_ 1}^{k} = {T}_{2} + {R}_{2} {P}_{VCS \_ 2}^{k} = {T}_{3} + {R}_{3} {P}_{VCS \_ 3}^{k} , \qquad ( 20 )$$

where subscripts 1, 2, and 3 denote Top, Left, and Right CSLDVs, respectively, and the superscript k is the index of the measurement point on the surface. P_{MCS} of all measurement points on the surface can be obtained using a 3D profile scanner that is an internal unit of the Polytec PSV-500-3D system. Therefore, the 3D profile scanner and three CSLDVs are in the same coordinate system with respect to the same reference object, and errors from interaction between devices can be reduced to a relatively low level. The original 3D profile of the test structure can be processed by a linear interpolation method to obtain a much denser measurement grid that can be input into scan mirrors to make them to continuously rotate. Coordinates of the point P^{k} in three VCSs are

$${P}_{VCS \_ 1}^{k} = {R}_{1}^{- 1} ( {P}_{MCS}^{k} - {T}_{1} ) , \qquad ( 21 a )$$

$${P}_{VCS \_ 2}^{k} = {R}_{2}^{- 1} ( {P}_{MCS}^{k} - {T}_{2} ) , \qquad ( 21 b )$$

$${P}_{VCS \_ 3}^{k} = {R}_{3}^{- 1} ( {P}_{MCS}^{k} - {T}_{3} ) . \qquad ( 21 c )$$

By Eq. (18), one has rotating angles of three CSLDVs:

$${α}_{1}^{k} = arctan ( {z}_{VCS\_ 1}^{k} / {y}_{VCS \_ 1}^{k} ) \qquad ( 22 a )$$

$${β}_{1}^{k} = arctan ( {x}_{VCS \_ 1}^{k} / ( {y}_{VCS \_ 1}^{k} / cos ( {α}_{1}^{k} ) - d ) ) ,$$

$${α}_{2}^{k} = arctan ( {z}_{VCS \_ 2}^{k} / {y}_{VCS \_ 2}^{k} ) \qquad ( 22 b )$$

$${β}_{2}^{k} = arctan ( {x}_{VCS \_ 2}^{k} / ( {y}_{VCS \_ 2}^{k} / cos ( {α}_{2}^{k} ) - d ) ) ,$$

$${α}_{3}^{k} = arctan ( {z}_{VCS \_ 3}^{k} / {y}_{VCS \_ 3}^{k} ) \qquad ( 22 c )$$

$${β}_{3}^{k} = arctan ( {x}_{VCS \_ 3}^{k} / ( {y}_{VCS \_ 3}^{k} / cos ( {α}_{3}^{k} ) - d ) ) .$$

By synchronously and continuously moving three laser spots along a pre-designed scan trajectory, velocities in three VCSs can be directly acquired in one measurement. To transform them to vibration components in the MCS, the following equation can be established using calculated direction cosine matrices and unit vectors:

$${[ {V}_{x} , {V}_{y} , {V}_{z} ]}^{T} = {{[ {[ {R}_{1} {e}_{1} , {R}_{2} {e}_{2} , {R}_{3} {e}_{3} ]}^{T} ]}^{- 1} [ {V}_{1} , {V}_{2} , {V}_{3} ]}^{T} \qquad ( 23 )$$

where V₁, V₂, and V₃ are directly acquired velocities from top, left, and right CSLDVs, respectively, and Vₓ, V_{y}, and V_{z} are transformed velocity components along three directions of the MCS, respectively. The obtained real-time 3D velocity components can be used to not only monitor the test structure in its operating condition, but also estimate its DNFs and 3D FF-UMSs via a signal processing procedure.

The governing partial differential equation of a linear, time-invariant, viscously damped structure under external excitation can be solved to obtain its response at a spatial position x:

$$u ( x , t ) = {\sum }_{i = 1}^{N} {ϕ}_{i} ( x ) {ϕ}_{i} ( {x}_{p} ) [ {A}_{i} ( t ) cos ( {ω}_{d , i} t ) + {B}_{i} ( t ) sin ( {ω}_{d , i} t ) + {C}_{i} ( t ) ] , \qquad ( 24 )$$

where xₚ denotes the position of a concentrated force, t is time, N is the total number of points on the measurement grid, ϕᵢ is the i-th mass-normalized eigenfunction of the associated undamped structure, Aₜ (t), Bᵢ (t), and Cᵢ (t) are arbitrary functions of time related to the concentrated force, and ω_{d,i} is the i-th DNF of the structure that can be obtained by applying a fast Fourier transform (FFT) on response. Filtering the response u in Eq. (24) to allow ω_{d,i} to pass yields

$${u}_{i} ( x , t ) = {Φ}_{i} ( x ) cos ( {ω}_{d , i} t - φ ) = {Φ}_{I , i} ( x ) cos ( {ω}_{d , i} t ) + {Φ}_{Q , i} ( x ) sin ( {ω}_{d , i} t ) , \qquad ( 25 )$$

where Φᵢ(x) are responses with in-phase and quadrature components Φ_{1,i} (x) and Φ_{Q,i} (x), respectively, at measurement points along the scan trajectory, and φ is the phase variable.

To obtain Φ_{1,i} (x) and Φ_{Q,i}(x), multiplying uᵢ (x,t) in Eq. (11) by cos (ω_{d,i}t) and sin (ω_{d,i}t) yield

$$\begin{matrix}{u}_{i} ( x , t ) cos ( {ω}_{d , i} t ) = {Φ}_{I , i} ( x ) {cos}^{2} ( {ω}_{d , i} t ) + {Φ}_{Q , i} ( x ) sin ( {ω}_{d , i} t ) cos ( {ω}_{d , i} t ) \\ = \frac{1}{2} {Φ}_{I , i} ( x ) + \frac{1}{2} {Φ}_{I , i} ( x ) cos ( 2 {ω}_{d , i} t ) + \frac{1}{2} {Φ}_{Q , i} ( x ) sin ( 2 {ω}_{d , i} t ) ,\end{matrix} \qquad ( 26 )$$

$$\begin{matrix}{u}_{i} ( x , t ) sin ( {ω}_{d , i} t ) = {Φ}_{I , i} ( x ) sin ( {ω}_{d , i} t ) cos ( {ω}_{d , i} t ) + {Φ}_{Q , i} ( x ) {sin}^{2} ( {ω}_{d , i} t ) \\ = \frac{1}{2} {Φ}_{Q , i} ( x ) + \frac{1}{2} {Φ}_{I , i} ( x ) sin ( 2 {ω}_{d , i} t ) - \frac{1}{2} {Φ}_{Q , i} ( x ) cos ( 2 {ω}_{d , i} t ) ,\end{matrix} \qquad ( 27 )$$

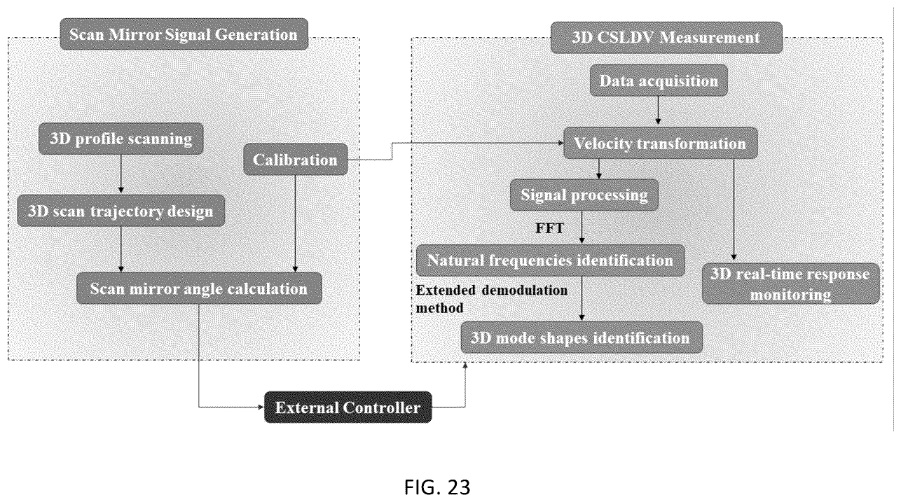

respectively, where Φ_{1,i} (x) and Φ_{Q,i}(x) can be subsequently obtained by using a low-pass filter to remove sin (2ω_{d,i}t) and cos (2ω_{d,i}t). By applying the above procedure on the designed 3D zig-zag scan trajectory, EDM can be extended from one dimension to three dimensions and can be used to identify DNFs and 3D FF-UMSs of a turbine blade with a curved surface under random excitation. Corresponding steps are shown in FIG. 23, which is a flow diagram having steps of scan mirror signals generated and 3D CSLDV measurement.

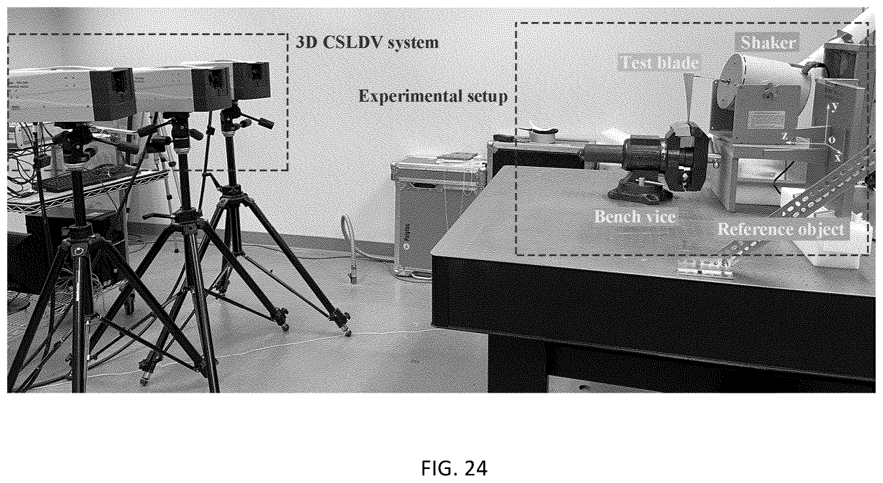

In experiments, a turbine blade was used as the test sample. It was manufactured from a trapezoidal plate with a thickness of 3.5 mm, two bases of 42 mm and 26 mm, and an altitude of 173.9 mm via twisting. One end of the turbine blade was viced onto a workbench to simulate its clamped-free boundaries. FIG. 24 is an image of an experimental setup for testing relative position of the test turbine blade and the 3D CSLDV system and details of the setup of the test turbine blade including its boundary conditions and position in the MCS. One can see from FIG. 24 that excitation was provided by a MODAL-50 shaker from MB Dynamics via a stinger attached on the free end of the turbine blade. Note that the arrangement of three laser heads is close to a plane instead of a cone, as shown in FIG. 24, since modes of interest in this study are mostly bending or torsion modes, not longitudinal modes. To enhance signal intensity of laser spots, the turbine blade was covered by a reflective tape on its surface. The MCS is determined by the reference object. As shown in FIG. 24, the turbine blade is parallel to the o-xy plane of the MCS built on the reference object, its out-of-plane vibration component is along the z direction, and its in-plane vibration components are along x and y directions. A periodic chirp signal whose frequency covers the range of 0 to 3000 Hz was used in the modal test of the turbine blade by the 3D SLDV system for 900 s, and a white-noise signal whose frequency covers the range of 0 to 3000 Hz was used as random excitation in its 3D CSLDV measurement for 115.5 s.

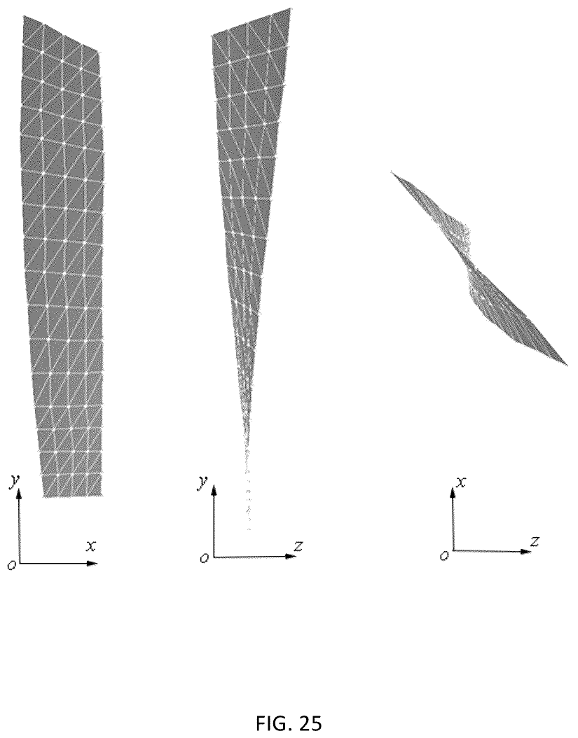

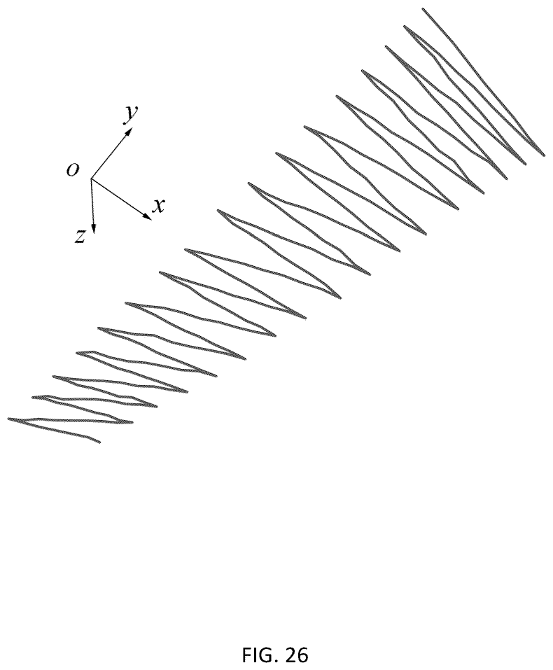

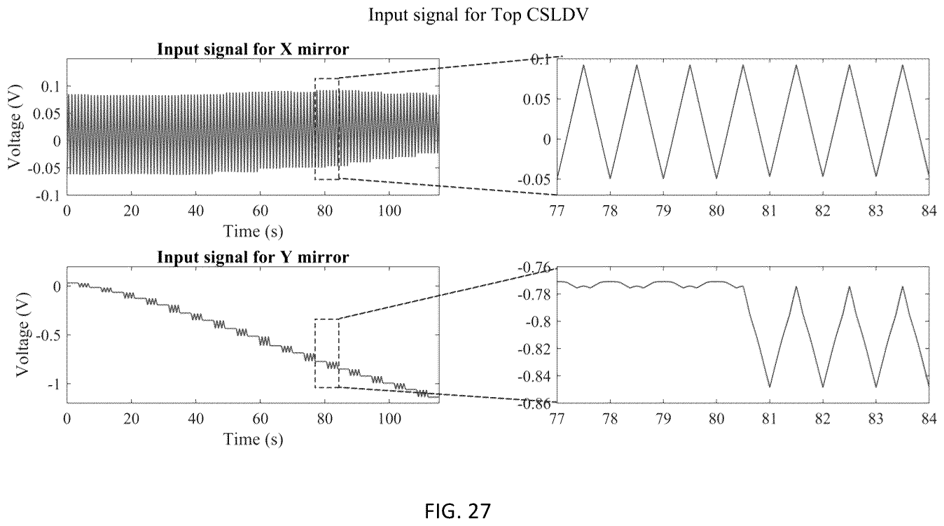

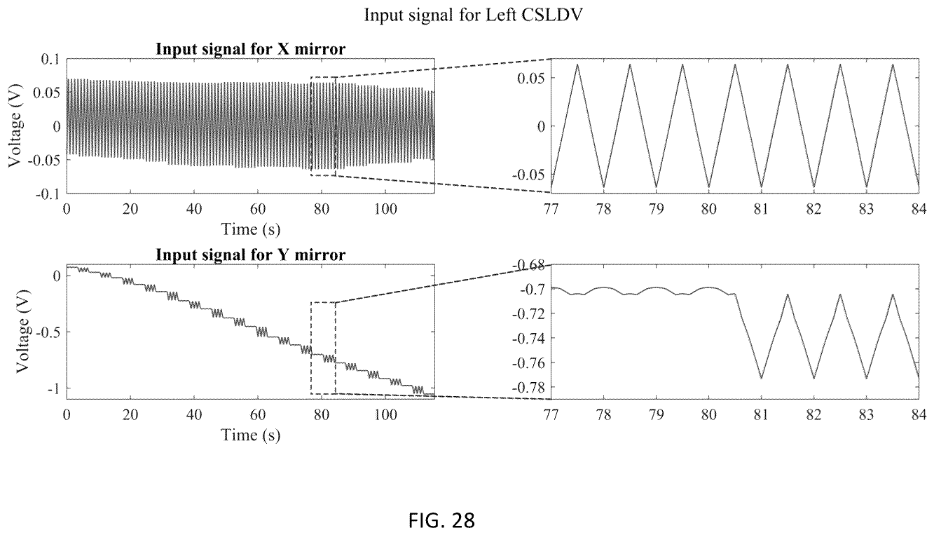

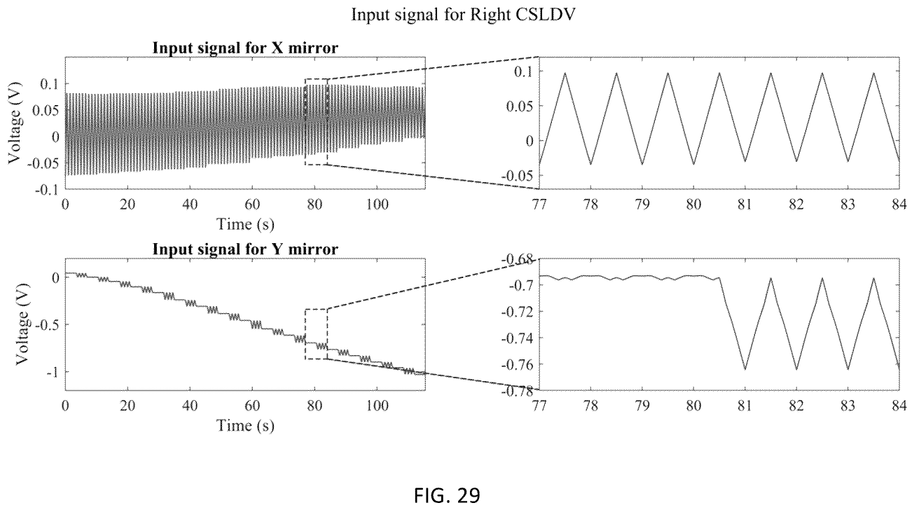

Prior to the design of the 3D scan trajectory, the 3D profile of the turbine blade was measured. FIG. 25 illustrates graphs showing grid of measurement points and the 3D profile of the surface of the turbine blade. Referring to FIG. 25, a grid of 17×5 points were used as reference points for profile scanning and measurement points for SLDV measurement, and then linearly interpolated to be a denser grid that includes 33 scan lines for continuous scanning. FIG. 26 illustrates a diagram showing 3D zig-zag scan trajectory pre-designed for the turbine blade to cover its full surface. The zig-zag scan trajectory, as shown in FIG. 26, was used since this experiment focused on processing response of a structure under random excitation using the EDM, and the zig-zag scan trajectory is more easily processed by the demodulation method than other scan trajectories. In CSLDV measurement, the time of moving laser spots along a scan line for a full cycle can be defined as a scanning period T, and the scanning frequency ƒ_{sca}=1/T is 1 Hz in this experiment. To denoise measured response, a three-time average was conducted for both 3D SLDV and CSLDV measurements. Therefore, it took 1=33×3.5=115.5 s to conduct a full-field scanning on the surface of the turbine blade, where 3.5 means the number of periods for each scan line. Scan mirror signals of top, left, and right CSLDVs can be found in FIGS. 27-29, respectively, whose right subplots show details of two cycles. FIG. 27 illustrates a diagram showing scan mirror signals for the Top CSLDV based on the 3D zig-zag scan trajectory in FIG. 26. FIG. 28 illustrates a diagram showing scan mirror signals for the Left CSLDV based on the 3D zig-zag scan trajectory in FIG. 26. FIG. 29 illustrates a diagram showing scan mirror signals for the right CSLDV based on the 3D zig-zag scan trajectory in FIG. 26. Time-voltage series for X and Y mirrors are triangular and curved, respectively, and much different from those in measurements of structures with planar surfaces.

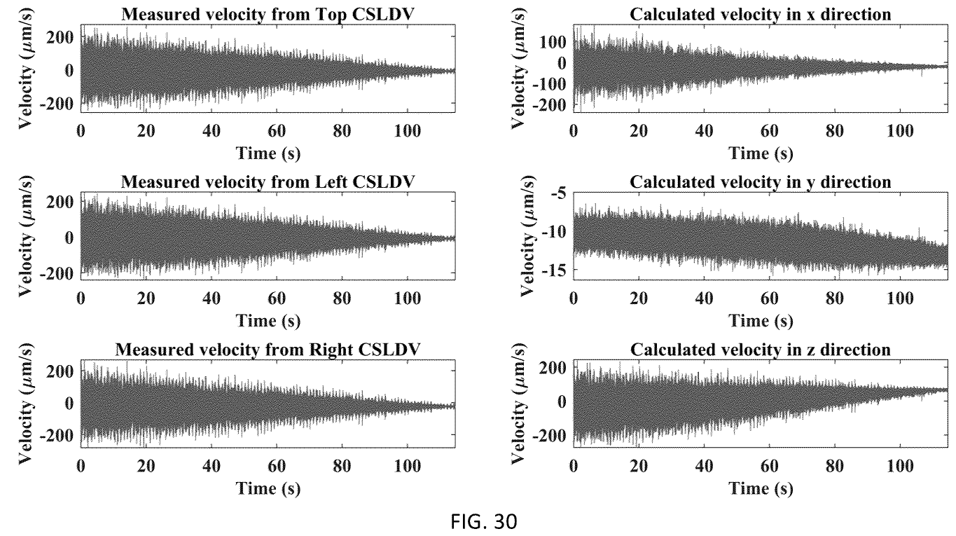

Directly measured vibrations in the experiment are in three VCSs of three CSLDVs, which can be transformed to three orthogonal velocity components in the same MCS using Eq. (9). Directly measured and transformed velocities of the turbine blade excited by white noise are shown in FIG. 30, which illustrates graphs showing transformation from velocities measured in VCSs to three orthogonal components in the defined MCS. Directly measured velocities in three VCSs and transformed velocities along three orthogonal axes in the MCS can be found in left and right subplots, respectively, where y axes are velocities and x axes are time. In FIG. 30, velocities at the beginning of time axes have much larger values than those at ends of time axes, since laser spots were moved from the free end of the turbine blade to its clamped end during measurement. Free-clamped boundaries of the turbine blade also led to a much smaller amplitude of the velocity along the y direction in the MCS than those along the other two directions. One can see that directly measured velocities in VCSs and the transformed velocity along the z direction have similar shapes. The reason is that velocities in VCSs are along laser beams of CSLDVs whose directions are close to that of the defined z direction in the MCS.

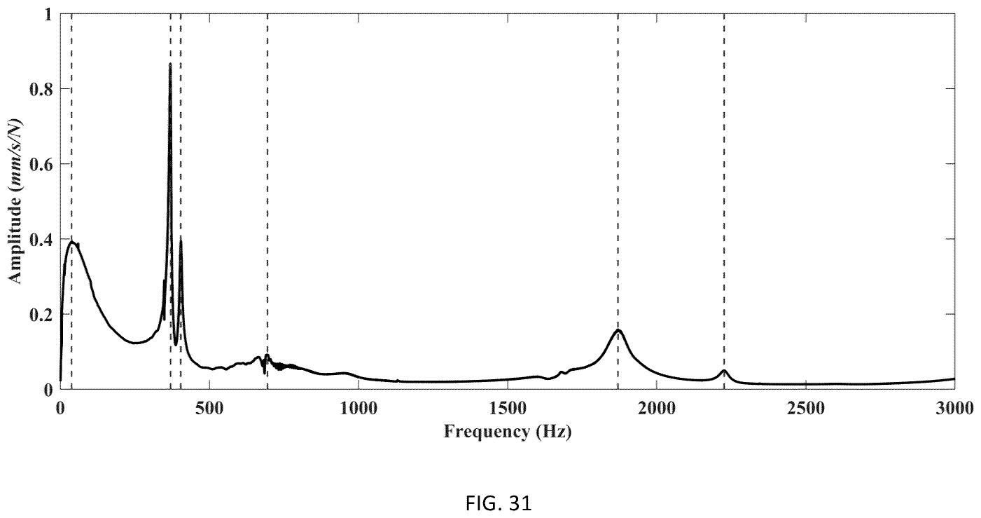

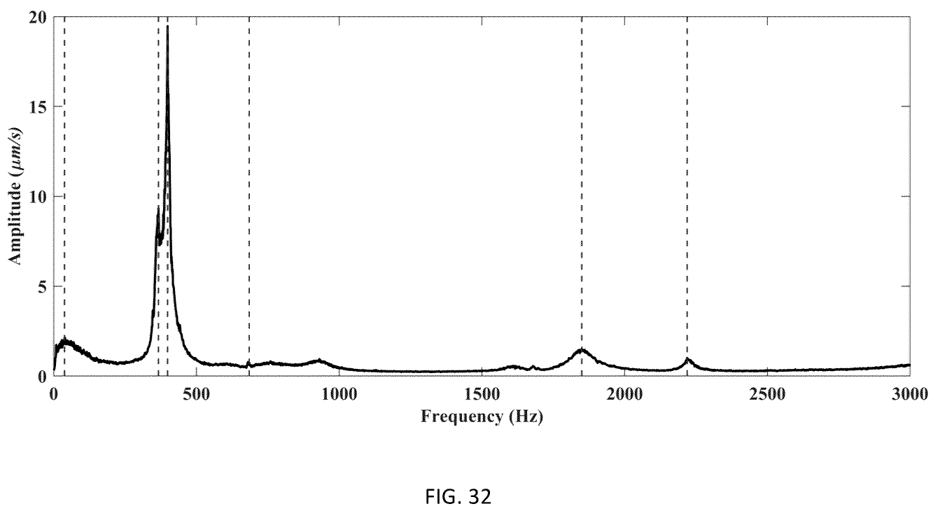

Data acquisition of 3D CSLDV measurement has a sampling frequency of ƒₛₐ=8,000 Hz. As a result, the total number of 3D CSLDV measurement points is k=0.5×8000×33=132,000. Comparisons between the consumed test time and the number of scanned points by the 3D CSLDV system and those by the 3D SLDV system are made in this work. It can be seen from Table 3 that a total of 85 measurement points were scanned by the 3D SLDV system in 900 s, while 132,000 points were scanned by the 3D CSLDV system in 115.5 s, which means that the 3D CSLDV system has much higher efficiency than the 3D SLDV system in identifying 3D modal parameters of the turbine blade. Frequency spectra of the turbine blade from the two systems are shown as black solid lines in FIGS. 31 and 32, respectively, where the first six DNFs of the turbine blade shown as red dashed lines can be identified in the frequency range from 0 to 3000 Hz. Note that amplitudes of frequency spectra are different since different excitation signals are used in SLDV and CSLDV measurements. Comparison between the first six DNFs of the turbine blade identified from measurement by the 3D CSLDV system and those by the SLDV system are shown in Table 4. Differences between the first six DNFs identified by the two systems are less than 1.5%.

TABLE 3
Comparisons between the consumed test time
and the number of scanned points by the 3D
CSLDV system and those by the 3D SLDV system

| Measurement method | 3D CSLDV | 3D SLDV |
|---|---|---|
| Consumed test time (s) | 115.5 | 900 |
| Number of scanned points | 132,000 | 85 |

TABLE 4
Comparison between the first six DNFs of the
turbine blade identified by two systems

| | DNF (Hz) | | |
|---|---|---|---|
| | 3D CSLDV | 3D SLDV | |
| Mode No. | measurement | measurement | Difference (%) |
| 1 | 38 | 37.5 | 1.3 |
| 2 | 367 | 370.5 | 0.9 |
| 3 | 399 | 403.3 | 1.1 |
| 4 | 685 | 695.1 | 1.5 |
| 5 | 1850 | 1870.8 | 1.1 |
| 6 | 2219 | 2226.3 | 0.3 |

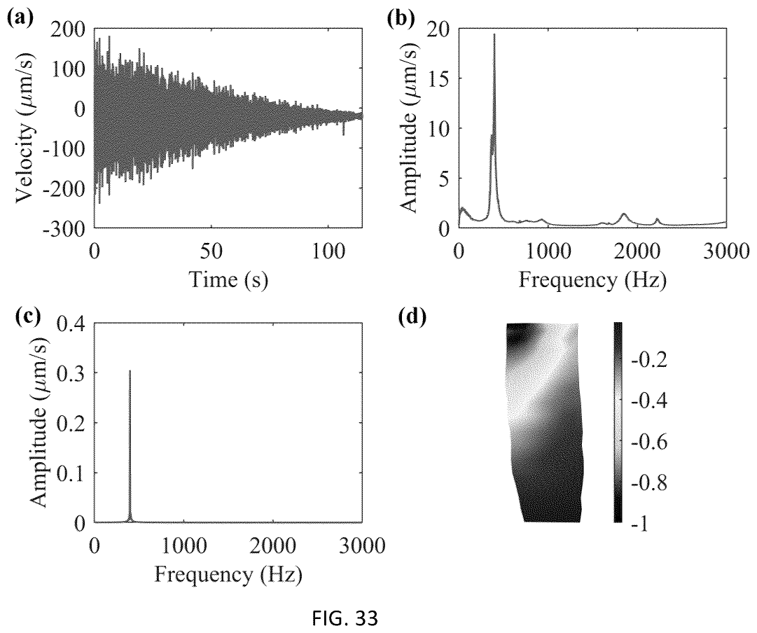

The procedure of identifying the x component of the mode shape of the turbine blade at its third damped natural frequency of 399 Hz, which can be obtained from the third peak in the frequency spectrum in FIG. 32, is used to explain details of the EDM described herein. An initial step, as shown in FIG. 33 (section (a)-(b)), is to obtain the i-th DNF ω_{d,i} of the turbine blade by processing its vibration component in the x direction of the MCS via the FFT. The following step is to filter raw response in the first step using its identified DNF. In this case, the third DNF of 399 Hz is selected, and the used filter has a passband of 398 to 400 Hz. The frequency spectrum shown in section (c) of FIG. 33 is filtered response. The final step is to multiply filtered response from the second step by sinusoidal signals cos (ω_{d,i}t) and sin (ω_{d,i}t), where ω_{d,i} is the identified DNF, and apply a low-pass filter with a cutting frequency of 1 Hz to multiplied response to remove sin (2ω_{d,i}t) and cos (2ω_{d,i}t) in Eqs. (26) and (27), respectively, to obtain the i-th UMS of the turbine blade. The normalized x component of the third UMS of the turbine blade using a unit maximum absolute component value can be seen in section (d) of FIG. 33.

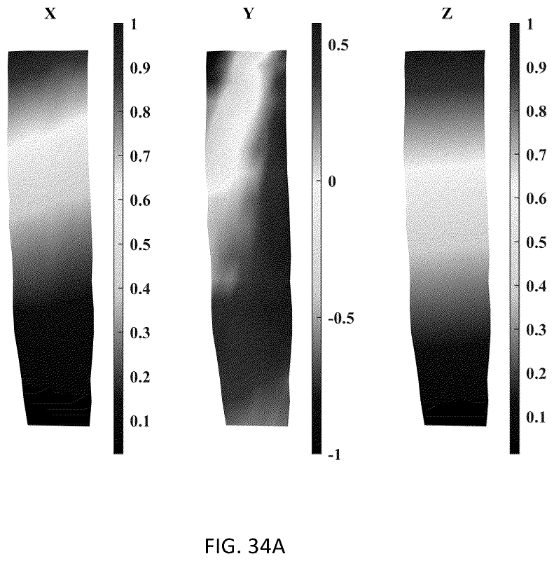

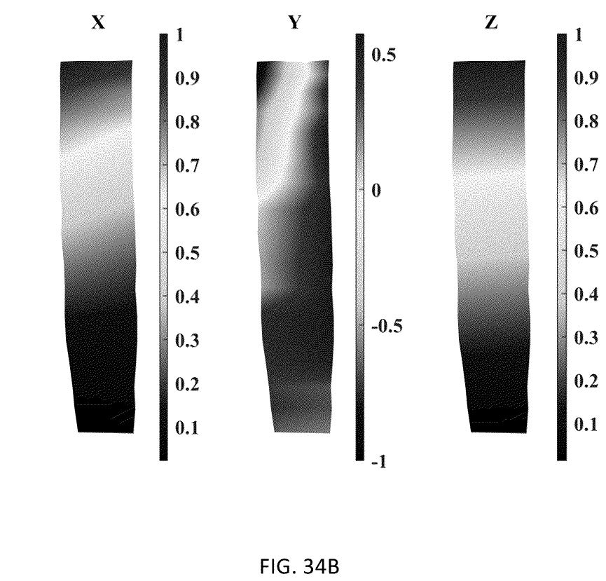

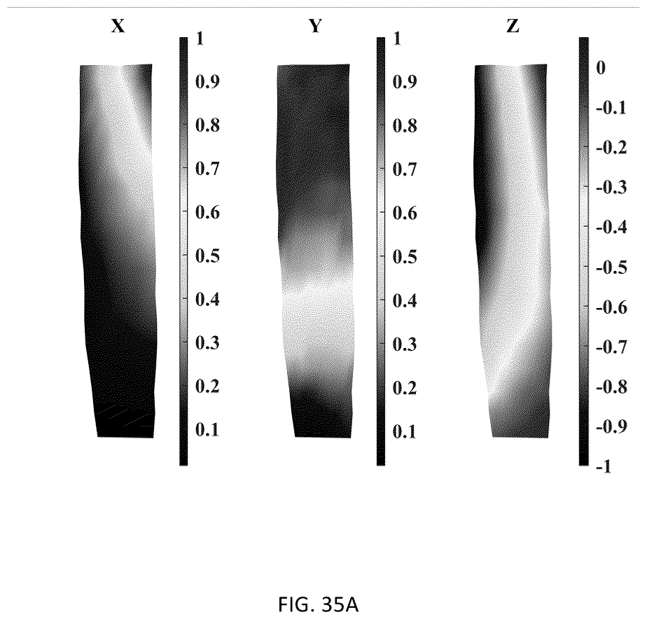

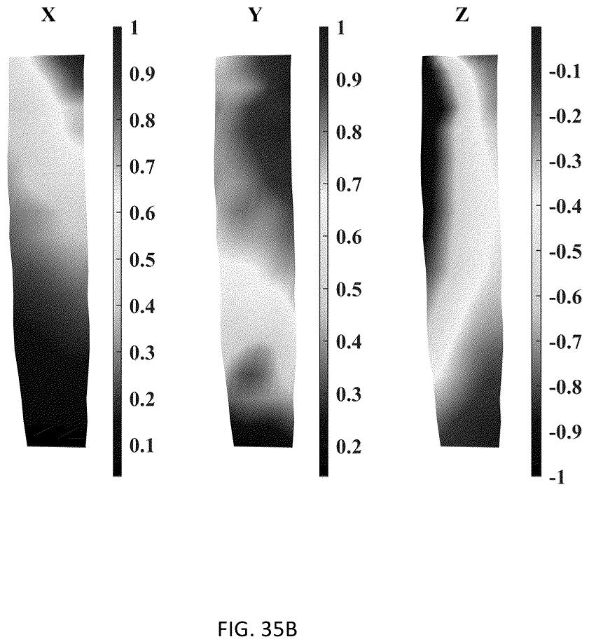

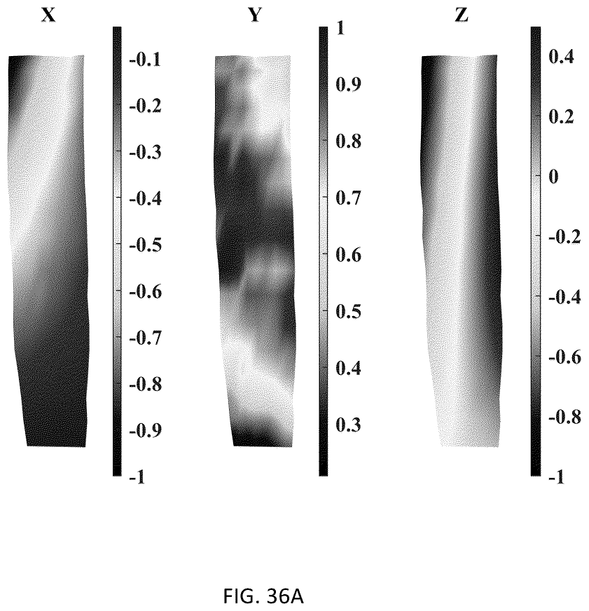

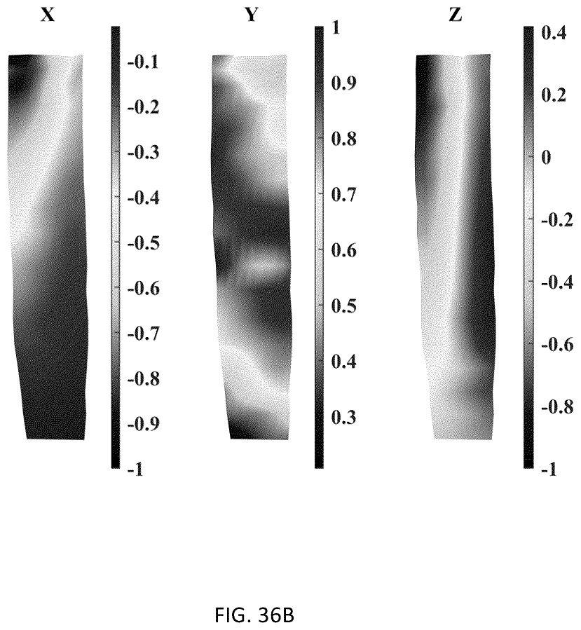

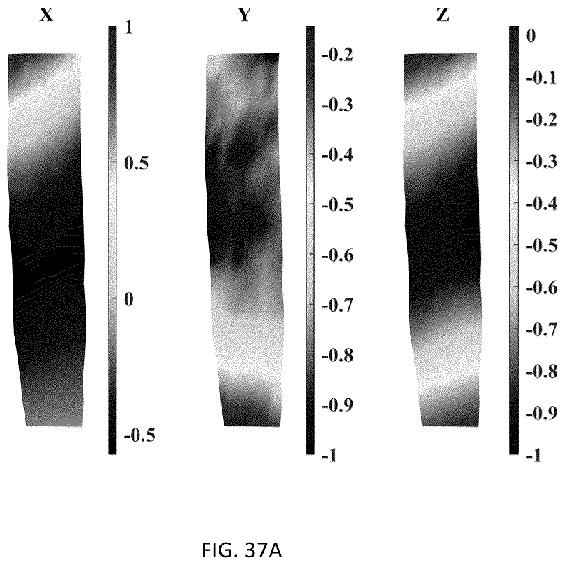

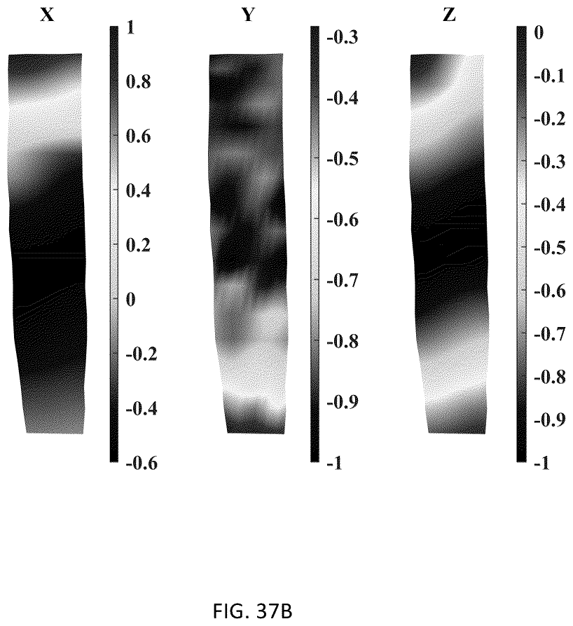

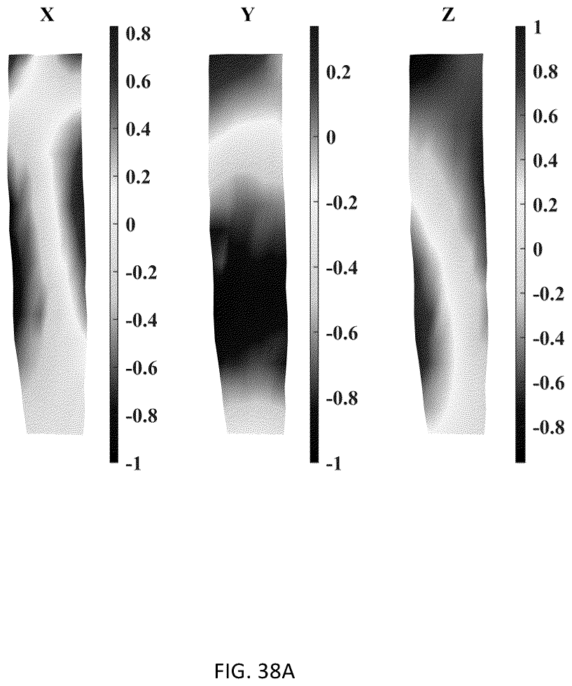

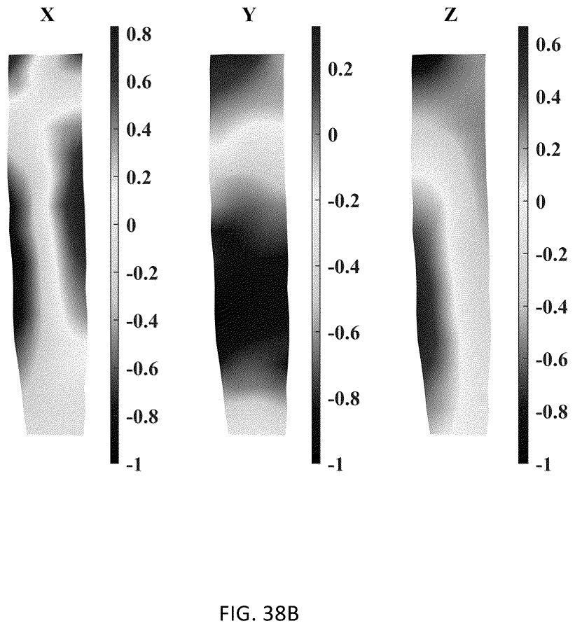

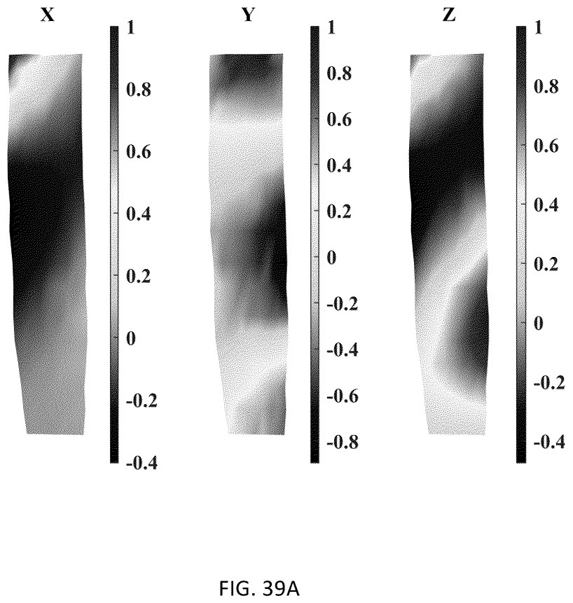

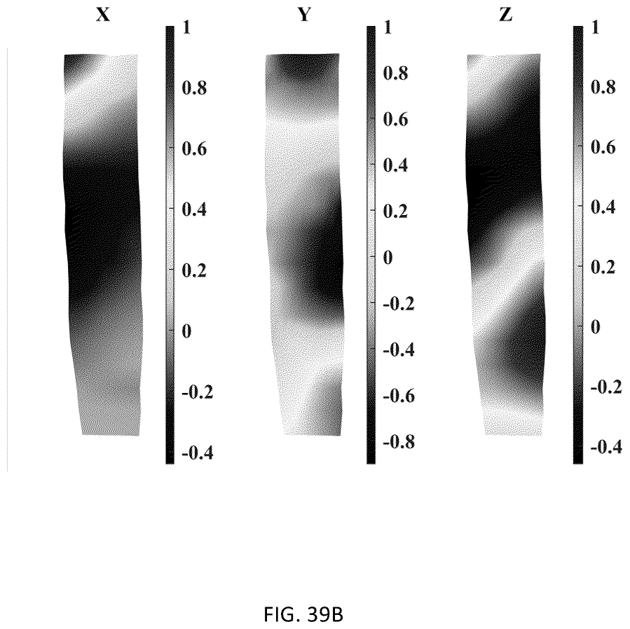

The first six 3D FF-UMSs of the test turbine blade estimated by the 3D CSLDV system and corresponding full-field damped mode shapes (FF-DMSs) estimated by the 3D SLDV system can be found in FIGS. 34A-39B, where left ones are FF-DMSs estimated by the 3D SLDV system and right ones are FF-UMSs estimated by the 3D CSLDV system. Mode shape components along three directions of each mode are normalized by the maximum value of all the components in the three directions. In each subplot, mode shape components shown from left to right are those from x, y, and z directions, respectively. DMSs of the turbine blade estimated by the 3D SLDV system can be compared with its corresponding UMSs estimated by the 3D CSLDV system since it has relatively small damping ratios. One can see that the second, third, and fifth FF-UMSs estimated by the 3D CSLDV system are torsional modes and the first, fourth, and sixth FF-UMSs estimated by the 3D CSLDV system are bending modes, which are similar to corresponding FF-DMSs estimated by the 3D SLDV system. Mode shapes from both systems have less smooth components along the y direction than the other two directions, since it is more difficult for a cantilever structure to excite its longitudinal vibration than its transverse vibration, which leads to smaller SNRs along the y direction than the other two directions; this fits results of 3D real-time response shown in FIG. 40. Another reason may be that arrangement of three laser heads is close to a plane instead of a cone, which leads to a slightly smaller response amplitude along the y direction. MAC values between 3D FF-UMSs of the turbine blade estimated by the 3D CSLDV system and its FF-DMSs estimated by the 3D SLDV system are calculated and shown in Table 5, where one can see that MAC values between mode shapes estimated by the two systems have a minimum value of 95% for all the six modes, showing high correlations and the same level of accuracy between estimated mode shapes from the proposed 3D CSLDV system and the commercial 3D SLDV system.

TABLE 5
MAC values between 3D FF-UMSs of the turbine blade
estimated by the 3D CSLDV system and corresponding
FF-DMSs estimated by the 3D SLDV system

| Mode | | | |
|---|---|---|---|
| number | x component | y component | z component |
| 1 | 100% | 98.7% | 100% |
| 2 | 95.3% | 98.1% | 98.1% |
| 3 | 99.5% | 99.2% | 98.5% |
| 4 | 96.5% | 98.2% | 99.5% |
| 5 | 95.7% | 99.8% | 95% |
| 6 | 95.6% | 98.6% | 96.4% |

DNFs and 3D FF-UMSs of a clamped-free turbine blade with a curved surface under random excitation are identified by the novel 3D CSLDV system via the EDM. Three CSLDVs, an external controller, and a profile scanner are used to build the 3D CSLDV system. In order to ensure that three laser spots can synchronously and continuously move along the same scan trajectory, spatial relations among the three CSLDVs are determined via a calibration procedure, and used with the 3D profile of the turbine blade to design a 3D full-field trajectory to scan its surface. The first six modal parameters of the turbine blade identified from measurement by the 3D CSLDV system are compared with those by the SLDV system. Differences between the first six DNFs identified by the two systems are less than 1.5%, and MAC values between mode shapes estimated by two systems have a minimum value of 95% for all the six modes, indicating that the 3D CSLDV system proposed in this study have the same accuracy as that of the commercial 3D SLDV system in modal parameter estimation. In modal testing of the turbine blade, the number of points scanned by the 3D CSLDV system is about 1,500 times that by the 3D SLDV system, while the consumed test time by the 3D CSLDV system is less than ⅛ of that by the 3D SLDV system, which means that the 3D CSLDV system has much higher efficiency in identifying 3D modal parameters of the turbine blade than the 3D SLDV system.

When any two arbitrary points are selected from the reference object, the spatial distance between them keeps constant in any two different coordinate systems. For two reference points in coordinate systems MCS and VCS defined in this study, it can be written as

$$\vert {P}_{MCS}^{m} - {P}_{MCS}^{n} \vert = \vert {P}_{VCS}^{m} - {P}_{VCS}^{n} \vert . \qquad ( 28 )$$

By assuming that a total number of H (H≥4) points are selected for calibration, m is from 1 to H−1 and n is from m+1 to H. An over-determined nonlinear problem with H(H−1)/2 equations like Eq. (28) can be solved to obtain exact values of r via the nonlinear least squares method, in which initial values of r can be inputted using roughly measured distances from incident points of laser beams on the X mirror to selected points. Six points with coordinates (−150,150,0), (150,150,0), (150,−150,0), (−150,−150,0), (−5,25,80), and (−5,−35,150) are selected from four corners and two poles of the reference object, as shown in FIG. 40, which is an image that shows details of the reference object and points marked by circles for calibration purposes. R and T can be solved via the following optimization problem:

$$F ( T , R ) = δ = min {\sum }_{m = 1}^{H} \vert {P}_{MCS}^{m} - ( T + {RP}_{VCS}^{m} ) \vert . \qquad ( 29 )$$

In the MCS, let P̅_{MCS}=(Σₘ₌₁^{H} P_{MCS}^{m})/H, w_{MCS}^{m}=P_{MCS}^{m}−P̅_{MCS}, and Q_{MCS}=[q_{MCS}¹, q_{MCS}², . . . , q_{MCS}^{H}]. Similarly, in the VCS, Q_{VCS}=[q_{VCS}¹, q_{VCS}², . . . , q_{VCS}^{H}] can be constructed by P̅_{VCS}=(Σₘ₌₁^{HH}P_{VCS}^{m})/H and q_{VCS}^{m}=P_{VCS}^{m}−P_{VCS}. A 3×3 matrix A can be obtained by A=Q_{VCS}Q_{MCS}^{T}, and can also be decomposed through the singular value decomposition A=UΣV^{T}, where U and V are two 3×3 orthogonal matrices, and Σ is a 3×3 diagonal matrix with non-negative real numbers on the diagonal. One can use U and V to obtain R and T via

$$R = V [ \begin{matrix}1 & 0 & 0 \\ 0 & 1 & 0 \\ 0 & 0 & \vert {VU}^{T} \vert\end{matrix} ] {U}^{T} , \qquad ( 30 )$$

$$and$$

$$T = {\overline{P}}_{MCS} - R {\overline{P}}_{VCS} . \qquad ( 31 )$$

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

### REFERENCES

[1] S. J. Rothberg, M. S. Allen, P. Castellini, D. Di Maio, J. J. J. Dirckx, D. J. Ewins, B. J. Halkon, P. Muyshondt, N. Paone, T. Ryan, H. Steger, E. P. Tomasini, S. Vanlanduit, J. F. Vignola, An international review of laser Doppler vibrometry: Making light work of vibration measurement, Opt. Lasers Eng., 99 (2017), pp. 11-22. https://doi.org/10.1016/j.optlaseng.2016.10.023.
[2] P. Castellini, M. Martarelli, E. P. Tomasini, Laser Doppler Vibrometry: Development of advanced solutions answering to technology's needs, Mech. Syst. Signal Process., 20 (6) (2006), pp. 1265-1285. https://doi.org/10.1016/j.ymssp.2005.11.015.
[3] J. La, J. Choi, S. Wang, K. Kim, K. Park, Continuous scanning laser Doppler vibrometer for mode shape analysis, Opt. Eng., 42 (3) (2003), pp. 730-737. https://doi.org/10.1117/1.1533794.
[4] P. Margerit, T. Gobin, A. Lebée, J. F. Caron, The robotized laser Doppler vibrometer: On the use of an industrial robot arm to perform 3D full-field velocity measurements, Opt. Lasers Eng., 137 (2021), p. 106363. https://doi.org/10.1016/j.optlaseng.2020.106363.
[5] S. Sels, S. Vanlanduit, B. Bogaerts, R. Penne, Three-dimensional full-field vibration measurements using a handheld single-point laser Doppler vibrometer, Mech. Syst. Signal Process., 126 (2019), pp. 427-438. https://doi.org/10.1016/j.ymssp.2019.02.024.
[6] T. Miyashita, Y. Fujino, Development of 3D vibration measurement system using laser doppler vibrometers, in: Health Monitoring and Smart Nondestructive Evaluation of Structural and Biological Systems V, SPIE, 2006, pp. 170-179. https://doi.org/10.1117/12.662159.
[7] P. O'Malley, T. Woods, J. Judge, J. Vignola, Five-axis scanning laser vibrometry for three-dimensional measurements of non-planar surfaces. Meas. Sci. Technol., 20 (11) (2009), p. 115901. http://doi.org/10.1088/0957-0233/20/11/115901.
[8] D. Di Maio, E. Copertaro, Experimental validation of a newly designed 6 degrees of freedom scanning laser head: application to three-dimensional beam structure, Rev. Sci. Instrum., 84 (12) (2013), p. 121708. https://doi.org/10.1063/1.4845535.
[9] D. Kim, H. Song, H. Khalil, J. Lee, S. Wang and K. Park, 3-D vibration measurement using a single laser scanning vibrometer by moving to three different locations, IEEE Trans. Instrum. Meas., 63 (8) (2014), pp. 2028-2033. https://doi.org/10.1063/1.4845535.
[10] D. M. Chen, W. D. Zhu, Investigation of three-dimensional vibration measurement by a single scanning laser Doppler vibrometer, J. Sound Vib., 387 (2017), pp. 36-52. https://doi.org/10.1016/j.jsv.2016.09.026.
[11] K. Bendel, M. Fischer, M. Schuessler, Vibrational analysis of power tools using a novel three-dimensional scanning vibrometer, in: Sixth International Conference on Vibration Measurements by Laser Techniques: Advances and Applications, SPIE, 2014, pp. 177-184. https://doi.org/10.1117/12.579525.
[12] W. Xu, W. D. Zhu, S. A. Smith, M. S. Cao, Structural damage detection using slopes of longitudinal vibration shapes, J. Vib. Acoust., 138 (3) (2016), p. 034501. https://doi.org/10.1115/1.4031996.
[13] K. Yuan, W. Zhu, Modeling of welded joints in a pyramidal truss sandwich panel using beam and shell finite elements, J. Vib. Acoust., 143 (4) (2021), p. 041002. https://doi.org/10.1115/1.4048792.
[14] Y. Chen, A. S. Mendoza, D. T. Griffith, Experimental and numerical study of high-order complex curvature mode shape and mode coupling on a three-bladed wind turbine assembly, Mech. Syst. Signal Process., 160 (2021), p. 107873. https://doi.org/10.1016/j.ymssp.2021.107873.
[15] C. Vuye, S. Vanlanduit, F. Presczniak, G. Steenackers, P. Guillaume, Optical measurement of the dynamic strain field of a fan blade using a 3D scanning vibrometer, Opt. Lasers Eng., 49 (7) (2011), pp. 988-997. https://doi.org/10.1016/j.optlaseng.2011.01.021.
[16] B. J. Halkon, S. R. Frizzel, S. J. Rothberg, Vibration measurements using continuous scanning laser vibrometry: velocity sensitivity model experimental validation, Meas. Sci. Technol., 14 (6) (2003), pp. 773-783. https://doi.org/10.1088/0957-0233/14/6/310.
[17] D. Di Maio, P. Castellini, M. Martarelli, S. Rothberg, M. S. Allen, W. D. Zhu, D. J. Ewins, Continuous Scanning Laser Vibrometry: A raison d′être and applications to vibration measurements. Mech. Syst. Signal Process., 156 (2021), p. 107573. https://doi.org/10.1016/j.ymssp.2020.107573.
[18] L. F. Lyu, W. D. Zhu, Operational modal analysis of a rotating structure under ambient excitation using a tracking continuously scanning laser Doppler vibrometer system, Mech. Syst. Signal Process., 152 (2021), p. 107367. https://doi.org/10.1016/j.ymssp.2020.107367.
[19] L. F. Lyu, W. D. Zhu, Full-field mode shape estimation of a rotating structure subject to random excitation using a tracking continuously scanning laser Doppler vibrometer via a two-dimensional scan scheme, Mech. Syst. Signal Process., 169 (2022), p. 108532. https://doi.org/10.1016/j.ymssp.2021.108532.
[20] D. M. Chen, Y. F. Xu, W. D. Zhu, Damage identification of beams using a continuously scanning laser doppler vibrometer system, J. Vib. Acoust., 138 (5) (2016), p. 051011. https://doi.org/10.1115/1.4033639.
[21] D. M. Chen, Y. F. Xu, W. D. Zhu, Experimental investigation of notch-type damage identification with a curvature-based method by using a continuously scanning laser doppler vibrometer system, J. Nondestruct. Eval., 36 (2017), p. 38. https://doi.org/10.1007/s10921-017-0418-4.
[22] D. M. Chen, Y. F. Xu, W. D. Zhu, Identification of damage in plates using full-field measurement with a continuously scanning laser Doppler vibrometer system, J. Sound Vib., 422 (2018), pp. 542-567. https://doi.org/10.1016/j.jsv.2018.01.005.
Y. F. Xu, D. M. Chen, W. D. Zhu, Operational modal analysis using lifted continuously scanning laser Doppler vibrometer measurements and its application to baseline-free structural damage identification, J. Vib. Control, 25 (7) (2019), pp. 1341-1364. https://doi.org/10.1177/1077546318821154.
[24] B. Weckes, D. Ewins, Multi-frequency, 3D ODS measurement by continuous scan laser Doppler vibrometry, Mech. Syst. Signal Process., 58-59 (2015), pp. 325-539. https://doi.org/10.1016/j.ymssp.2014.12.022.
[25] D. M. Chen, W. D. Zhu, Investigation of three-dimensional vibration measurement by three scanning laser Doppler vibrometers in a continuously and synchronously scanning mode, J. Sound Vib., 498 (2021) p. 115950. https://doi.org/10.1016/j.jsv.2021.115950.
[26] K. Yuan, W. D. Zhu, Estimation of modal parameters of a beam under random excitation using a novel 3D continuously scanning laser Doppler vibrometer system and an extended demodulation method, Mech. Syst. Signal Process., 155 (2021), p. 107606. https://doi.org/10.1016/j.ymssp.2021.107606.
[27] K. Yuan, W. D. Zhu, In-plane operating deflection shape measurement of an aluminum plate using a three-dimensional continuously scanning laser Doppler vibrometer system, Exp. Mech., 62 (2022), p. 667-676. https://doi.org/10.1007/s11340-021-00801-x.
[28] A. B. Stanbridge, D. J. Ewins, Modal testing using a scanning laser Doppler vibrometer, Mech. Syst. Signal Process., 13 (2) (1999), pp. 255-270. https://doi.org/10.1006/mssp.1998.1209.
[29] K. S. Arun, T. S. Huang, S. D. Blostein, Least-squares fitting of two 3-D point sets, IEEE Trans. Pattern Anal. Mach. Intell., 9 (5) (1985), pp. 698-700. 10.1109/TPAMI.1987.4767965.
[30] D. J. Ewins, Modal Testing: Theory, Practice and Application, second ed., Research Studies Press LTD, Hertfordshire, 2000.
[31] K. Yuan, W. Zhu, A Novel General-purpose Three-dimensional Continuously Scanning Laser Doppler Vibrometer System for Full-field Vibration Measurement of a Structure with a Curved Surface, Journal of Sound and Vibration 540 (2022) 117274.
[32] M. S. Allen, M. W. Sracic, A new method for processing impact excited continuous-scan laser Doppler vibrometer measurements, Mechanical Systems and Signal Processing 24 (3) (2010) 721-735.
[33] S. Vanlanduit, P. Guillaume, and J. Schoukens, Broadband vibration measurements using a continuously scanning laser vibrometer, Measurement Science and Technology 13 (10) (2002) 1574-1582.
[34] D. Di Maio, D. J. Ewins, Continuous Scan, a method for performing modal testing using meaningful measurement parameters; Part I, Mechanical Systems and Signal Processing 25 (8) (2011) 3027-3042.
[35] S. Yang, M. S. Allen, Output-only modal analysis using continuous-scan laser Doppler vibrometry and application to a 20 KW wind turbine, Mechanical Systems and Signal Processing 31 (2012) 228-245.
[36] L. F. Lyu, W. D. Zhu, Operational modal analysis of a rotating structure subject to random excitation using a tracking continuously scanning laser Doppler vibrometer via an improved demodulation method, Journal of Vibration and Acoustics 144 (1) (2022) 011006.
[37] K. S. Arun, T. S. Huang, S. D. Blostein, Least-squares fitting of two 3-D point sets, IEEE Transactions on Pattern Analysis and Machine Intelligence 5 (1987) 698-700.
[38] L. Meirovitch, Analytical methods in vibrations, The Macmillan Co, 1967.
[39] D. J. Ewins, Modal Testing: Theory, Practice, and Application, 2nd ed., Research Studies Press Ltd., Hertfordshire, U K, 2000.

What is claimed is:

1. A three-dimensional (3D) continuously scanning laser vibrometer (CSLV) system comprising:
first, second, and third laser heads with mirrors configured to be positioned for scanning a curved surface of a structure;
a profile scanner configured to determine a 3D scan trajectory for the curved surface of a structure; and
a computing device operably connected to the first, second, and third laser heads, wherein the computing device is configured to:
control the first, second, and third laser heads to scan the curved surface of the structure based on the determined 3D scan trajectory;
measure the 3D vibrations of the curved surface of the structure; and
determine operating deflection shapes (ODSs) and mode shapes of the structure based on the measured 3D vibrations of the curved surface of the structure.

2. The system of claim 1, wherein the computing device is configured to control the first, second, and third laser heads to continuously and synchronously move along the same scan trajectory on the curved surface of the structure.

3. The system of claim 1, wherein the second and third laser heads are positioned between about 30 degrees and 60 degrees relative to the first laser head.

4. The system of claim 1, wherein the computing device is configured to use a reference object as a measurement coordinate system for calibration.

5. The system of claim 1, wherein the first, second, and third laser heads measure 3D vibrations of the curved surface of the structure under sinusoidal excitation.

6. The system of claim 1, wherein the computing device is configured to determine vibration of the structure based on the measured 3D vibrations of the curved surface of the structure.

7. The system of claim 1, wherein the 3D scan trajectory is an approximate zig-zag scan path.

8. The system of claim 1, wherein the computing device is configured to use a demodulation technique to determine the 3D operating deflection shapes of the structure.

9. The system of claim 1, wherein the curved surface of the structure is under random excitation, and
wherein an extended demodulation method (EDM) is configured to estimate damped natural frequencies and 3D full-field undamped mode shapes of the structure under random excitation.

10. The system of claim 1, wherein the system is a 3D continuously scanning laser Doppler vibrometer system.

11. A method comprising:
using a profile scanner to determine a three-dimensional (3D) scan trajectory for a curved surface of a structure;
positioning first, second, and third laser heads for scanning the curved surface of the structure;
controlling the first, second, and third laser heads to scan the curved surface of the structure based on the determined 3D scan trajectory;
measuring the 3D vibrations of the curved surface of the structure; and
determining operating deflection shapes (ODSs) of the structure based on the measured 3D vibrations of the curved surface of the structure.

12. The method of claim 11, further comprising controlling the first, second, and third laser heads to continuously and synchronously move along the same scan trajectory on the curved surface of the structure.

13. The method of claim 11, wherein the second and third laser heads are positioned between about 30 degrees and 60 degrees relative to the first laser head.

14. The method of claim 11, further comprising using a reference object as a measurement coordinate system for calibration.

15. The method of claim 11, further comprising controlling the first, second, and third laser heads to measure 3D vibrations of the curved surface of the structure under sinusoidal excitation.

16. The method of claim 11, further comprising determining vibration of the structure based on the measured 3D vibrations of the curved surface of the structure.

17. The method of claim 11, wherein the 3D scan trajectory is an approximate zig-zag scan path.

18. The method of claim 11, further comprising using a demodulation technique to determine the 3D operating deflection shapes of the structure.

19. The method of claim 11, wherein the curved surface of the structure is under random excitation, and
wherein the method comprises using an extended demodulation method (EDM) estimate damped natural frequencies and 3D full-field undamped mode shapes of the structure under random excitation.

20. The method of claim 11, wherein the first, second, and third laser heads are part of a 3D continuously scanning laser Doppler vibrometer system.
